(19) United States
(12) Patent Application Publication
(10) Pub. No.: US 2025/0024374 A1
(43) Pub. Date: Jan. 16, 2025

(54) Wake-Up Signal

(71) Applicant: Telefonakiebolaget LM Ericsson (publ), Stockholm (SE)

(72) Inventors: Andreas Höglund, Solna (SE); Talha Khan, Santa Clara, CA (US); Olof Liberg, Enskede (SE); Leif Wilhelmsson, Lund (SE); Mohammad Mozaffari, Fremont, CA (US); Miguel Lopez, Aachen (DE)

(21) Appl. No.: 18/712,777

(22) PCT Filed: Nov. 23, 2022
(86) PCT No.: PCT/SE2022/051097

§ 371 Date: May 23, 2024

Related U.S. Application Data
(60) Provisional application No. 63/282,953, filed on Nov. 24, 2021.

(51) Int. Cl. H04W 52/02; H04L 1/00

(52) U.S. Cl. CPC H04W 52/0235; H04L 1/0047; H04W 52/0219

(57) ABSTRACT

A first communication node (12) in a wireless communication network (10) monitors for a cell-specific wake-up signal (20). The first communication node (12) may monitor for the cell-specific wake-up signal (20) with a wake-up receiver (12W). The first communication node (12) in particular may monitor for a cell-specific wake-up signal (20) that is any of multiple cell-specific wake-up signals (20) in a set. In some embodiments, the set is re-used for different sets of cells. Alternatively or additionally, the set may include cell-specific wake-up signals (20) that are based on multiple respective binary sequences, based on different codewords of a binary error correcting code, based on different orthogonal sequences in a set, composed of different sets of Zadoff-Chu sequences with different roots, composed of the same set of Zadoff-Chu sequences with different cyclic shifts, or a function of different cyclic shifts of a root wake-up signal formed by multiple Zadoff-Chu sequences with different roots.

### TECHNICAL FIELD

The present application relates generally to a communication network, and relates more particularly to a wake-up signal and use thereof in such a network.

### BACKGROUND

A wireless communication network transmits a paging message to a wireless communication device in order to trigger the device to connect to the wireless communication network, e.g., for receiving downlink user data. The paging message may for instance be transmitted over a downlink control channel, e.g., a Physical Downlink Control Channel (PDCCH). A wireless communication device in this case must monitor and decode the downlink control channel in order to determine whether any paging message is intended for the device. Such monitoring and decoding, however, consumes device power and negatively impacts device battery life.

Reduced power consumption can be realized by the use of a so-called wake-up signal (WUS). A wake-up signal is a signal that indicates a wireless communication device is to wake-up one or more receiver components, if needed, and monitor a downlink control channel, e.g., for any paging message intended for the device. A wake-up signal is designed so that it can be detected more quickly and/or without consuming as much power as compared to monitoring and decoding a downlink control channel. Exploiting a wake-up signal affords a wireless communication device more frequent opportunities to operate in a low power mode. 20 e.g., in between occasions in which the device is to monitor for the wake-up signal.

Yet additional power conservation can be realized by using a so-called wake-up receiver (WUR) to monitor for and receive the wake-up signal. A wake-up receiver is a receiver that is capable of receiving a wake-up signal and that is separate from another receiver (referred to as a main receiver) which is woken up upon the wake-up receiver receiving the wake-up signal. The wake-up receiver's circuitry is less complex and/or more power efficient than the main receiver. This may mean that the main receiver is capable of receiving some signals or channels that the wake-up receiver cannot. For example, the main receiver may be capable of receiving one or more other signals or channels (e.g., PDCCH) needed for connecting to the wireless communication network, but the wake-up receiver may not be capable of receiving such signals or channels. Relieved of the need to receive the other signal(s) or channel(s), the wake-up receiver can be simplified and more power efficient than the main receiver. The wake-up receiver may for instance be dedicated for receiving the wake-up signal, and optionally, a synchronization signal. Or, even if not so dedicated, the wake-up receiver may be dedicated or tailored for receiving one or more signals or channels in a Radio Resource Control (RRC) idle state or an RRC inactive state, i.e., to the exclusion of one or more other signals or channels in an RRC connected state. In these and other cases, a wireless communication device may be equipped with both a wake-up receiver and another receiver (e.g., referred to as a main receiver) capable of receiving the other signal(s) or channel(s) that the wake-up receiver is not capable of receiving. The wireless communication device can then power down one or more components of its main receiver unless and until its wake-up receiver receives a wake-up signal.

Challenges nonetheless still exist in exploiting such a wake-up receiver. A wake-up signal that is receivable with a device's main receiver can be scrambled with a cell's identity in order to make the wake-up signal cell-specific. Cell-specific wake-up signals advantageously avoid wireless communication devices in one cell being unnecessarily woken up by a wake-up signal transmitted in another cell. However, it is not straightforward how to make a wake-up signal that would be receivable with a device's wake-up receiver cell-specific. Challenges therefore exist in exploiting a wake-up receiver while at the same time making the wake-up signal cell-specific.

### SUMMARY

One or more embodiments herein provide a wake-up signal that is cell-specific. In some embodiments, the cell-specific wake-up signal is generated and/or transmitted in such a way that it is receivable with a wake-up receiver. Some embodiments thereby enable communication nodes to be awaken by a wake-up signal in a cell-specific way while also exploiting a wake-up receiver for reception of the wake-up signal. These and other embodiments advantageously conserve resources and preserve communication node battery life by avoiding needlessly awakening communication nodes not targeted by a wake-up signal and by facilitating use of a lower power receiver for reception of the wake-up signal.

More particularly, embodiments herein include a method performed by a first communication node. The method comprises monitoring for a cell-specific wake-up signal.

In some embodiments, monitoring for a cell-specific wake-up signal comprises monitoring for any of multiple cell-specific wake-up signals in a set.

In some embodiments, the set of cell-specific wake-up signals is re-used for different sets of cells in a wireless communication network according to a reuse pattern, with each cell-specific wake-up signal being specific to one of multiple cells in a set of cells.

In some embodiments, the multiple cell-specific wake-up signals in the set are based on multiple respective binary sequences. In one such embodiment, monitoring comprises receiving a signal and determining which, if any, of the binary sequences matches the received signal.

In some embodiments where the multiple cell-specific wake-up signals in the set are based on multiple respective binary sequences, different ones of the binary sequences are a function of a base binary sequence with different respective auxiliary binary sequences.

In some embodiments, different ones of the binary sequences are formed from the modulo-two addition of the base binary sequence with different respective auxiliary binary sequences.

In some embodiments, the binary sequences comprise two binary sequences, and the auxiliary binary sequences comprise two auxiliary binary sequences that are orthogonal to one another. In one or more of these embodiments, determining which, if any, of the binary sequences matches the received signal comprises correlating the received signal with the base binary sequence and determining which of the binary sequences matches the received signal based on whether a correlation peak from said correlating is greater than or less than a detection threshold.

In other embodiments, the binary sequences comprise three or four binary sequences, and the auxiliary binary sequences comprises three or four auxiliary binary sequences that are orthogonal to one another.

In these and other embodiments, the base binary sequence may comprise the concatenation of multiple repetitions of a base binary subsequence. In one or more of these embodiments, a length of each auxiliary binary sequence may be equal to the number of the multiple repetitions.

In some embodiments where the base binary sequence comprises the concatenation of multiple repetitions of a base binary subsequence, determining which, if any, of the binary sequences matches the received signal comprises, for each of multiple sequential blocks of the received signal with a length corresponding to a length of the base binary sequence, correlating the block with the base binary subsequence, and determining which of the binary sequences matches the received signal by determining which of multiple candidate correlation peak patterns associated with respective ones of the binary sequences results from correlating. In one or more of these embodiments, determining which of multiple candidate correlation peak patterns associated with respective ones of the binary sequences results from correlating comprises, for each correlation peak resulting from said correlating, obtaining a correlation peak detection metric indicating whether the correlation peak is above or below a detection threshold, and determining which of the auxiliary binary sequences corresponds to a sequence formed from the correlation peak detection metrics. In other embodiments, determining which of multiple candidate correlation peak patterns associated with respective ones of the binary sequences results from correlating comprises, from correlation peaks resulting from correlating obtaining different combined correlation peak detection metrics corresponding to the auxiliary binary sequences, and determining which of the binary sequences matches the received signal based on which of the combined correlation peak detection metrics exceeds a detection threshold.

In some embodiments, the cell-specific wake-up signal is formed by multiple Zadoff-Chu sequences with different roots. In one or more of these embodiments, the multiple Zadoff-Chu sequences are a pair of Zadoff-Chu sequences. In some embodiments, at least one of the multiple Zadoff-Chu sequences is a complex conjugate of at least one other of the multiple Zadoff-Chu sequences. In some embodiments, the cell-specific wake-up signal is formed by a concatenation of the multiple Zadoff-Chu sequences with different roots. In some embodiments, the concatenation is in the time domain and/or the frequency domain.

In some embodiments, monitoring for a cell-specific wake-up signal comprises monitoring for any of multiple cell-specific wake-up signals in a set. In some embodiments, at least some of the cell-specific wake-up signals in the set are composed of different sets of Zadoff-Chu sequences with different roots, or the same set of Zadoff-Chu sequences with different cyclic shifts. In some embodiments, the multiple cell-specific wake-up signals are formable from a set of root Zadoff-Chu sequences. In this case, the method further comprises receiving information broadcast in a cell and determining the set of root Zadoff-Chu sequences from the information, and the information indicates one or more of a set of cell identities, a synchronization signal block configuration, or registration or tracking area information. In some embodiments, monitoring for a cell-specific wake-up signal comprises monitoring for any of multiple cell-specific group wake-up signals in a set. In this case, the cell-specific group wake-up signals are cell-specific wake-up signals for different groups of first communication nodes and are a function of different cyclic shifts of a root wake-up signal, and the root wake-up signal is formed by multiple Zadoff-Chu sequences with different roots.

In some embodiments, the cell-specific wake-up signal is based on a binary error correcting code.

In some embodiments, monitoring for a cell-specific wake-up signal comprises monitoring for any of multiple cell-specific wake-up signals in a set. In this case, different cell-specific wake-up signals in the set are based on different codewords of a binary error correcting code. In some embodiments, the different cell-specific wake-up signals in the set are formed from the modulo-two addition of different codewords with different pseudo-random sequences.

In some embodiments, monitoring for a cell-specific wake-up signal comprises monitoring for any of multiple cell-specific wake-up signals in a set. In this case, different cell-specific wake-up signals in the set are based on different orthogonal sequences in a set. In some embodiments, the different orthogonal sequences each comprise a cell-specific subsequence concatenated with a device-addressing subsequence, and orthogonal sequences specific to different cells are formed from different cell-specific subsequences.

In some embodiments, the cell-specific wake-up signal carries information that indicates a cell identity of a cell for which the cell-specific wake-up signal is specific.

In some embodiments, monitoring for a cell-specific wake-up signal comprises monitoring for at least some different cell-specific wake-up signals in different radio resources. In one or more of these embodiments, at least some of the different radio resources are non-overlapping in time and/or frequency.

In some embodiments, monitoring for a cell-specific wake-up signal comprises monitoring for at least some different cell-specific wake-up signals that have different periodicities, frequency hopping patterns, and/or repetition factors.

In some embodiments, monitoring for the cell-specific wake-up signal comprises monitoring for the cell-specific wake-up signal using non-coherent detection.

In some embodiments, the cell-specific wake-up signal is an OOK signal, an FSK signal, a PSK signal, or an ASK signal.

In some embodiments, monitoring comprises monitoring for the cell-specific wake-up signal with a wake-up receiver of the first communication node. In some embodiments, the wake-up receiver is a non-coherent receiver. In some embodiments, the method further comprises receiving the cell-specific wake-up signal with the wake-up receiver. In some embodiments, the method further comprises, based on receiving the wake-up signal, waking up one or more components of another receiver of the first communication node.

In some embodiments, the method further comprises, based on the wake-up signal, performing time and/or frequency synchronization with a second communication node from which the wake-up signal is received.

In some embodiments, the multiple Zadoff-Chu sequences are jointly received using the same time-frequency resources.

Other embodiments herein include a method performed by a second communication node. The method comprises transmitting a cell-specific wake-up signal to a first communication node.

In some embodiments, the cell-specific wake-up signal comprises any of multiple cell-specific wake-up signals in a set. In one or more of these embodiments, the set of cell-specific wake-up signals is re-used for different sets of cells in a wireless communication network according to a reuse pattern, with each cell-specific wake-up signal being specific to one of multiple cells in a set of cells. In one or more of these embodiments, the multiple cell-specific wake-up signals in the set are based on multiple respective binary sequences. In one or more of these embodiments, different ones of the binary sequences are a function of a base binary sequence with different respective auxiliary binary sequences. In one or more of these embodiments, different ones of the binary sequences are formed from the modulo-two addition of the base binary sequence with different respective auxiliary binary sequences. In one or more of these embodiments, the binary sequences comprise two binary sequences, and the auxiliary binary sequences comprise two auxiliary binary sequences that are orthogonal to one another. In one or more of these embodiments, the binary sequences comprise three or four binary sequences, and the auxiliary binary sequences comprises three or four auxiliary binary sequences that are orthogonal to one another. In one or more of these embodiments, the base binary sequence comprises the concatenation of multiple repetitions of a base binary subsequence. In one or more of these embodiments, a length of each auxiliary binary sequence is equal to the number of said multiple repetitions.

In some embodiments, the cell-specific wake-up signal is formed by multiple Zadoff-Chu sequences with different roots. In one or more of these embodiments, the multiple Zadoff-Chu sequences are a pair of Zadoff-Chu sequences. In some embodiments, at least one of the multiple Zadoff-Chu sequences is a complex conjugate of at least one other of the multiple Zadoff-Chu sequences. In some embodiments, the cell-specific wake-up signal is formed by a concatenation of the multiple Zadoff-Chu sequences with different roots. In some embodiments, the concatenation is in the time domain and/or the frequency domain.

In some embodiments, the cell-specific wake-up signal is one of multiple cell-specific wake-up signals in a set. In this case, at least some of the cell-specific wake-up signals in the set are composed of different sets of Zadoff-Chu sequences with different roots or the same set of Zadoff-Chu sequences with different cyclic shifts. In some embodiments, the multiple cell-specific wake-up signals are formable from a set of root Zadoff-Chu sequences. In this case, the method further comprises broadcasting information in a cell indicating one or more of a set of cell identities, a synchronization signal block configuration, or registration or tracking area information.

In some embodiments, the cell-specific wake-up signal comprises one of multiple cell-specific group wake-up signals in a set. In this case, the cell-specific group wake-up signals are cell-specific wake-up signals for different groups of first communication nodes and are a function of different cyclic shifts of a root wake-up signal, and the root wake-up signal is formed by multiple Zadoff-Chu sequences with different roots.

In some embodiments, the cell-specific wake-up signal is based on a binary error correcting code.

In some embodiments, the cell-specific wake-up signal is one of multiple cell-specific wake-up signals in a set. In this case, different cell-specific wake-up signals in the set are based on different codewords of a binary error correcting code. In one or more of these embodiments, the different cell-specific wake-up signals in the set are formed from the modulo-two addition of different codewords with different pseudo-random sequences.

In some embodiments, the cell-specific wake-up signal is one of multiple cell-specific wake-up signals in a set. In this case, different cell-specific wake-up signals in the set are based on different orthogonal sequences in a set. In one or more of these embodiments, the different orthogonal sequences each comprise a cell-specific subsequence concatenated with a device-addressing subsequence. In this case, orthogonal sequences specific to different cells are formed from different cell-specific subsequences.

In some embodiments, the cell-specific wake-up signal carries information that indicates a cell identity of a cell for which the cell-specific wake-up signal is specific.

In some embodiments, transmitting the cell-specific wake-up signal comprises transmitting the cell-specific wake-up signal in radio resources different from radio resources in which another cell-specific wake-up signal is transmitted. In one or more of these embodiments, transmitting the cell-specific wake-up signal comprises transmitting the cell-specific wake-up signal in radio resources that do not overlap in time and/or frequency with radio resources in which another cell-specific wake-up signal is transmitted.

In some embodiments, transmitting the cell-specific wake-up signal comprises transmitting at least some different cell-specific wake-up signals with different periodicities, frequency hopping patterns, and/or repetition factors.

In some embodiments, the cell-specific wake-up signal is an OOK signal, an FSK signal, a PSK signal, or an ASK signal.

In some embodiments, the first communication node is equipped with wake-up receiver. In some embodiments, the cell-specific wake-up signal is receivable with a wake-up receiver. In one or more of these embodiments, the wake-up receiver is a non-coherent receiver.

In some embodiments, the multiple Zadoff-Chu sequences are jointly transmitted using the same time-frequency resources.

Embodiments herein also include corresponding apparatus, computer programs, and carriers of those computer programs.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of communication nodes according to some embodiments.

FIG. 2A is a block diagram of wake-up signal re-use according to some embodiments.

FIG. 2B is a block diagram of wake-up signal re-use according to other embodiments.

FIG. 3 is a block diagram of wake-up signal timing according to some embodiments.

FIG. 4 is a logic flow diagram of a method performed by a first communication node according to some embodiments.

FIG. 5 is a logic flow diagram of a method performed by a second communication node according to some embodiments.

FIG. 6 is a logic flow diagram of a method performed by a network node according to some embodiments.

FIG. 7 is a block diagram of a first communication node according to some embodiments.

FIG. 8 is a block diagram of a second communication node according to some embodiments.

FIG. 9 is a block diagram of a communication system in accordance with some embodiments.

FIG. 10 is a block diagram of a user equipment according to some embodiments.

FIG. 11 is a block diagram of a network node according to some embodiments.

FIG. 12 is a block diagram of a host according to some embodiments.

FIG. 13 is a block diagram of a virtualization environment according to some embodiments.

FIG. 14 is a block diagram of a host communicating via a network node with a UE over a partially wireless connection in accordance with some embodiments.

### DETAILED DESCRIPTION

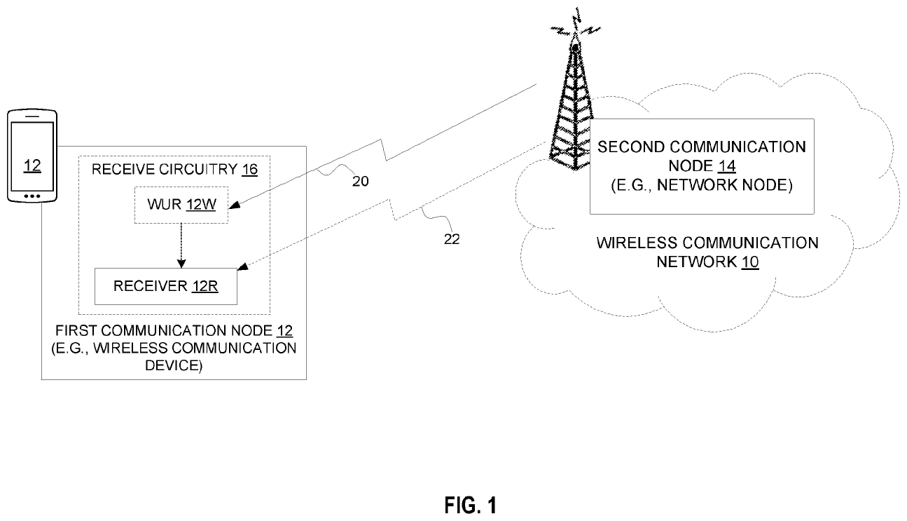

FIG. 1 shows a first communication node 12 and second communication node 14 according to some embodiments herein. In one embodiment as exemplified in FIG. 1, the first communication node 12 is a wireless communication device and the second communication node 14 is a network node in a wireless communication network 10. In another embodiment not shown, though, the first communication node 12 is a network node in a wireless communication network 10 and the second communication node 14 is a wireless communication device. In still another embodiment not shown, each of the first and second communication network nodes 12, 14 is a wireless communication device.

Regardless of the particular type of the communication nodes 12, 14, the first communication node 12 is equipped with receive circuitry 16 for receiving one or more signals or channels from the second communication node 14. One or more components of this receive circuitry 16 are configurable to be put to sleep, e.g., in a sleep state. When put to sleep, the sleeping component(s) consume less power than when awake, e.g., such that the sleep state may also be referred to as a low power state. The sleeping component(s) may for instance be powered down so as to be inoperable unless and until the component(s) are awaken, e.g., by control circuitry which may be separate from or a part of the receive circuitry 16.

As one example, the receive circuitry 16 may include or implement a receiver 12R. The receiver 12R is capable of receiving one or more signals or channels 22 needed for establishing a connection with the second communication node 14, e.g., a Physical Downlink Control Channel (PDCCH), and/or for user data reception. The receiver 12R may for instance be capable of receiving a Physical Downlink Control Channel (PDCCH), a Physical Downlink Shared Channel (PDSCH), and/or a Synchronization Signal Block (SSB), including a Primary Synchronization Signal (PSS) and a Secondary Synchronization Signal (SSS). The receiver 12R may therefore generally be usable for reception in a Radio Resource Control (RRC) connected mode.

In some embodiments, one or more components of the receiver 12R are configurable to be put to sleep. The first communication node 12 may for instance put these component(s) to sleep unless and until those component(s) are needed for receiving a PDCCH, e.g., for checking for a paging message. That is, before the receiver 12R is able to receive certain signal(s) or channel(s), the asleep component(s) must be awaken.

The second communication node 14 in this regard may transmit a wake-up signal (WUS) 20 to the first communication node 12. The wake-up signal 20 triggers the first communication node 12 to wake up one or more components of the receiver 12R from sleep.

In some embodiments, the receiver 12R itself is able to receive the wake-up signal 20, even when one or more components of the receiver 12R are asleep. For example, the component(s) put to sleep may be separate from the component(s) of the receiver 12R usable to receive the wake-up signal 20.

In other embodiments, by contrast, the receive circuitry 16 also includes or implements another receiver, referred to as a wake-up receiver (WUR) 12 W, that is capable of receiving the wake-up signal 20. The wake-up receiver 12W may not be capable of receiving the other one or more signals or channels 22, e.g., incapable of receiving PDCCH and/or PDSCH. The wake-up receiver 12W in some embodiments may even be dedicated to receiving the wake-up signal 20, and, optionally, a synchronization signal. Or, more generally, the wake-up receiver 12W may generally be usable for reception in an RRC idle mode or an RRC inactive mode, as compared to the receiver 12R which may be usable for reception in an RRC connected mode. Regardless, in some embodiments, use of the wake-up receiver 12W enables the first communication node 12 to put more components of the receiver 12R to sleep, since the receiver 12R in this case is relieved of the need to detect the wake-up signal 20. Accordingly, in some embodiments, the wake-up receiver 12W is simplified and more power efficient than the main receiver 12R.

In operation in this case, then, when the first communication node 12 does not need to receive the one or more signals or channels 22, such as when the first communication node 12 is in an RRC idle or inactive mode, the first communication node 12 operates the receiver 12R in a power-saving or sleep state, e.g., by powering down one or more components of the receiver 12R. During this time, though, the wake-up receiver 12W monitors for the wake-up signal 20. Reception of the wake-up signal 20 indicates to the first communication node 12 that the receiver 12R needs to be awaken in order to monitor for the one or more signals or channels 22. That is, the wake-up signal 20 indicates to wake-up one or more components of the receiver 12R. Accordingly, responsive to detecting the wake-up signal 20, the wake-up receiver 12W wakes up the one or more components of the receiver 12R, whereupon the receiver 12R monitors for the one or more signals or channels 22.

No matter which receiver 12R, 12 W is configured to receive the wake-up signal 20, some embodiments herein design the wake-up signal 20 to be cell-specific. With the wake-up signal 20 being cell-specific, transmission of the wake-up signal 20 in one cell will not wake up receiver circuitry of communication nodes in any neighboring cells. That is, the cell-specific nature of the wake-up signal 20 counteracts inter-cell interference.

More particularly, the cell-specific nature of the wake-up signal 20 means that the wake-up signal 20 is specific to a certain cell. In fact, in one embodiment, the wake-up signal 20 is unique to a certain cell. The uniqueness may be universal, extending to all cells in a wireless communication network 10. Or, the uniqueness may be local, extending to only a subset of the cells in the wireless communication network 10. In these and other embodiments, for instance, the wake-up signal 20 may be one of multiple cell-specific wake-up signals in a set, where each cell-specific wake-up signal in the set is specific to a respective one of multiple cells in a set of cells. In embodiments where this specificity is limited to the cells in the set, the set of cell-specific wake-up signals may be re-used for different sets of cells in the wireless communication network 10, e.g., according to a reuse pattern. The cell-specific wake-up signals may accordingly be transmitted in different radio resources, e.g., at least some of which may be non-overlapping in time and/or frequency.

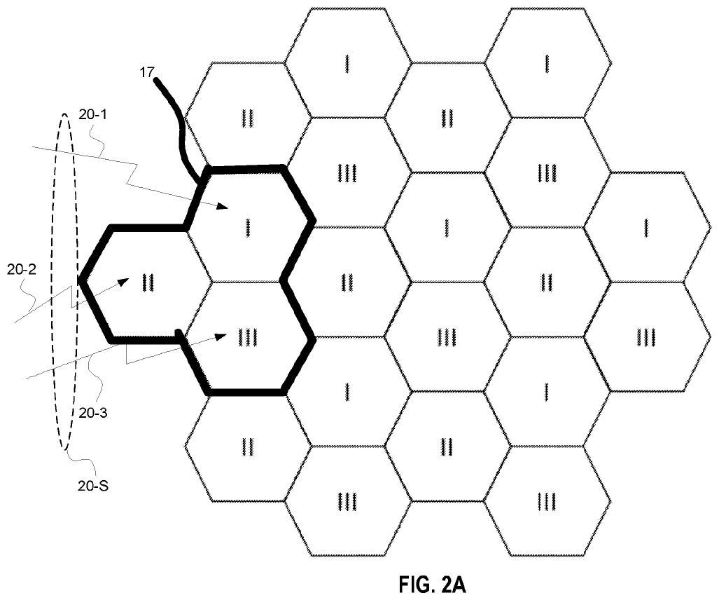

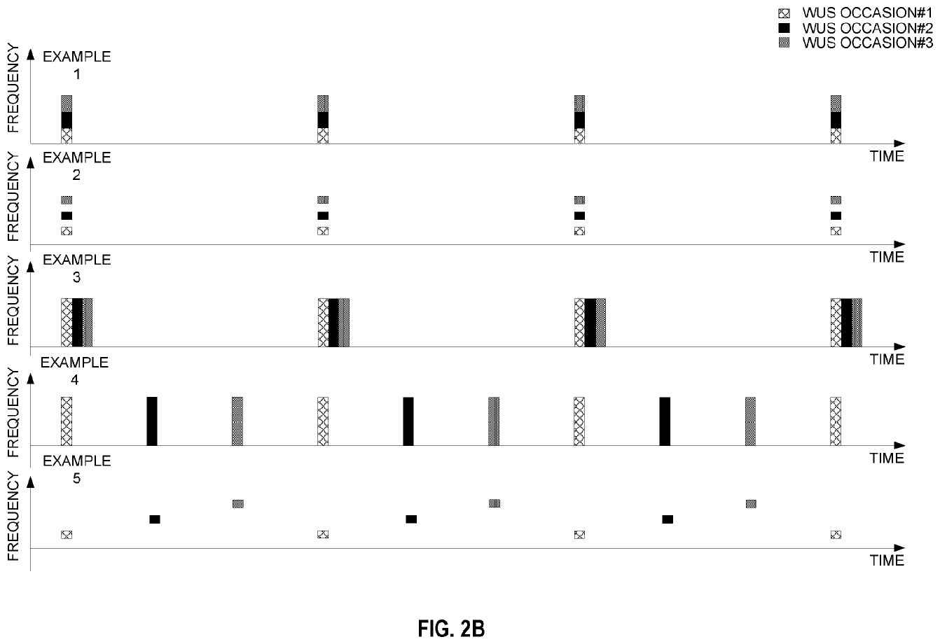

FIGS. 2A-2B show various embodiments in this regard. In FIG. 2A, there are three different wake-up signals 20-1, 20-2, and 20-3 in a set 20-S. These may also be referred to as different versions of a wake-up signal. The three wake-up signals 20-1, 20-2, and 20-3 are respectively transmitted within three cells I, II, and II that neighbor one another, i.e., in a cluster or set 17. Each wake-up signal 20-1, 20-2, and 20-3 is specific to a respective one of the multiple cells I, II, and Ill in this set 17. Moreover, these wake-up signals 20-1, 20-2, and 20-3 are re-used for different sets of cells according to the pattern shown, e.g., where the wake-up signals 20-1, 20-2, and 20-3 are transmitted in respective cells I, II, and Ill in each set of cells.

According to such a pattern in FIG. 2A, for example, the wake-up 20-1, 20-2, and 20-3 may be reused in a frequency reuse manner.

FIG. 2B shows various examples of other embodiments for re-use of wake-up signals across different sets of cells. As shown in Examples 1 and 2 of FIG. 2B, the wake-up signals may be re-used via frequency multiplexing. As shown in Examples 3 and 4, by contrast, the wake-up signals may be re-used via time multiplexing. And, as shown in Example 5, the wake-up signals may be re-used via a combination of time and frequency multiplexing.

Alternatively or additionally, cell-specific wake-up signal transmissions may be distinguished by different repetition factors, periodicities, and/or frequency hopping patterns. For example, a wake-up signal transmission from cell i can be specified with parameters (ai, bi, ci), to indicate repetition factor, periodicity, and frequency hopping pattern.

In another embodiment, time-frequency resources used for wake-up signal transmissions are determined based on one or more factors, including channel condition, inter-cell interference, wake-up receiver sensitivity, and/or wake-up receiver operation mode (always-on or DRX-based wake-up receiver). For example, in case of the wake-up receiver 12W is DRX-based, different cell-specific DRX cycles can be considered and wake-up signal occasions can match the DRX cycles, thus minimizing inter-cell interference and reducing the impact on communication nodes in neighboring cells (i.e., minimizing false wake up). In another embodiment, every N neighboring cells use non-overlapping time-frequency resources for wake-up signal transmissions. Specifically, a reuse time-frequency factor is defined for wake-up signal transmissions such that multiple cells can simultaneously transmit wake-up signals without impacting communication nodes in neighboring cells.

In one embodiment, at least two cells have at least non-overlapped time-frequency resources for their individual wake-up signal transmissions. The first communication node 12 may detect a wake-up signal occasion configured by the network 10 to at least the first communication node 12. The first communication node 12 may detect the wake-up signal occasion indicated by the network 10, or its serving cell, via System Information.

Notably, no matter the particular approach to wake-up signal re-use, the cell-specific wake-up signal 20 in some embodiments of FIG. 1 is generated and/or transmitted in such a way that it is receivable with receiver circuitry that is less complex and/or more power efficient as compared to existing wake-up signal designs. The cell-specific wake-up signal 20 may for instance be based on on-off keying (OOK), frequency shift keying (FSK), phase shift keying (PSK), and/or amplitude shift keying (ASK), and/or be detectable non-coherently. In these and other embodiments, then, the cell-specific wake-up signal 20 may be receivable with component(s) of the receiver 12R that stay awake while other component(s) of the receiver 12R sleep. Or, in other embodiments, the cell-specific wake-up signal 20 may be receivable with the wake-up receiver 12W. Some embodiments thereby enable the first communication node's receiver 12R to be awaken by a wake-up signal 20 in a cell-specific way while also exploiting a wake-up receiver 12W for reception of the wake-up signal 20. These and other embodiments advantageously conserve resources and preserve communication node battery life by avoiding needlessly awakening communication nodes not targeted by the wake-up signal 20 and by facilitating use of lower power receive circuitry for reception of the wake-up signal 20.

More specifically, in some embodiments where the wake-up signal 20 in FIG. 1 is one of multiple cell-specific wake-up signals in a set, the multiple cell-specific wake-up signals in the set may be based on multiple respective binary sequences. Binary sequences are suitable for low complexity receivers and can be modulated using modulations such as 2-FSK, OOK, or BPSK that can be supported by ultra-low power non-coherent wake-up receivers. In any event, the first communication node 12 in these embodiments may receive a signal and determine which, if any, of the binary sequences matches the received signal, e.g., via correlation with the received signal.

In one embodiment, for example, there are M different binary synchronization sequences, e.g., where M can be the frequency reuse factor, equal to 3 in the example illustrated in FIG. 2A. Some embodiments use M different sequences with good autocorrelation properties and use a filter bank with M correlators at the receiver. The correlator that yields the highest correlation peak would indicate the detected cell (up to the frequency re-use). However, this approach would require computation of M correlations in parallel, which has a cost in latency and power consumption. Other embodiments generate the M synchronization sequences such that it is possible to efficiently compute the M correlations, as follows.

Suppose that the length of the synchronization sequences is L>M, that the binary received signal is rₙ (e.g., an ultra-low complexity receiver may use a slicer to output a binary signal after analog to digital conversion). Some embodiments exploit a base binary synchronization sequence aₗ, l=1, . . . , L. Furthermore, an auxiliary binary sequence bₖ, k=1, . . . , K is introduced to generate all the synchronization sequences.

Consider first the case M=2. Set b₁=0, b₂=1 and define two synchronization sequences by a_{l,m}=aₗ⊕bₘ, m=1,2; l=1, . . . , L. (Here the symbol ⊕ denotes addition modulo 2). The correlations are computed by first mapping binary symbols±1, for example aₗ→aₗ=1-2aₗ, a_{l,m}=→a_{l,m}=1-2a_{l,m}, bₘ=>βₘ=1-2bₘ, rₙ→ρₙ=1−2rₙ, and then computing:

$$correlation ( m , n ) = {\sum }_{l = 1}^{L} {α}_{l , m} {ρ}_{n + l} .$$

Note that Σᵢ₌₁^{L} a_{l,m}ρₙ₊ᵢ=Σᵢ₌₁^{L}=aₗβₘρₙ₊₁=βₘΣₗ₌₁^{L}aₗρₙ₊₁. In other words, correlation(1, n)=−correlation(2, n). Hence, instead of a filter bank with M=2 correlators, only one correlator is needed. A positive detection threshold thresh is chosen, and the detection rules are:
1. Sequence m=1 detected if correlation (1, n)>thresh
2. Sequence m=2 detected if correlation (1, n)<thresh.

Consider next the case M=4. The base synchronization sequence is constructed from binary sequence eₗ of length

$$\frac{L}{2} : [ {e}_{1} , … , {e}_{\frac{L}{2}} ] .$$

The sequence eₗ is chosen with good auto-correlation properties. The four synchronization sequences are defined by

$$\begin{matrix}[ {a}_{1 , 1} , … , {a}_{L , 1} ] = [ {e}_{1} ⊕ 0 , … , {e}_{\frac{L}{2}} ⊕ 0 , {e}_{1} ⊕ 0 , … , {e}_{\frac{L}{2}} ⊕ 0 ] , \\ [ {a}_{1 , 2} , … , {a}_{L , 2} ] = [ {e}_{1} ⊕ 0 , … , {e}_{\frac{L}{2}} ⊕ 0 , {e}_{1} ⊕ 1 , … , {e}_{\frac{L}{2}} ⊕ 1 ] , \\ [ {a}_{1 , 3} , … , {a}_{L , 3} ] = [ {e}_{1} ⊕ 1 , … , {e}_{\frac{L}{2}} ⊕ 1 , {e}_{1} ⊕ 0 , … , {e}_{\frac{L}{2}} ⊕ 0 ] , \\ [ {a}_{1 , 4} , … , {a}_{L , 4} ] = [ {e}_{1} ⊕ 1 , … , {e}_{\frac{L}{2}} ⊕ 1 , {e}_{1} ⊕ 1 , … , {e}_{\frac{L}{2}} ⊕ 1 ] ,\end{matrix}$$

The correlation with the received signal is broken into two pieces of length

$$\frac{L}{2} .$$

Since the base sequence consists of a repetition of a subsequence with good correlation properties, the correlator exhibits two peaks when a wake-up signal is detected. A peak is detected when the correlation exceeds a chosen threshold. The detection rules are:
1. Sequence m=1 detected if both peaks are positive
2. Sequence m=2 detected if peak one is positive and peak two is negative
3. Sequence m=3 detected if peak one is negative and peak 2 is positive
4. Sequence m=4 is detected if peak one is negative and peak 2 is negative

Alternatively, at very low SNR the receiver may combine the partial correlations from the two halves and flip the partial sums according to four alternatives of sign combinations: {+1,+1}, {+1,−1}, {−1, +1}, {−1,−1}. As before, the combination that gives a positive peak exceeding a threshold determines one of four possible sequences.

Observe that the computational complexity exceeds the computational complexity of one correlator by a few operations, and is much less that the computational complexity of 4 independent correlators. Note also that it is possible to use only 3 of the 4 sequences, for example in case frequency re-use 3 is used.

In the general case, though, the base sequence is built by repeating K times a binary sequence et with good correlation properties, and changing the signs of the blocks containing each repetition according to some pattern. The receiver circuitry splits the computation of the correlation in K pieces, detects positive and/or negative peaks in every piece and the detection rule is determined by the pattern of signs in the peaks.

As these examples demonstrate, then, in one or more embodiments, different binary sequences are a function of a base binary sequence with different respective auxiliary binary sequences, e.g., that are orthogonal to one another. For example, different ones of the binary sequences may be formed from the modulo-two addition of the base binary sequence with different respective auxiliary binary sequences. Regardless, in some embodiments, determining which, if any, of the binary sequences matches the received signal comprises correlating the received signal with the base binary sequence and determining which of the binary sequences matches the received signal based on whether a correlation peak from the correlation is greater than or less than a detection threshold.

In other embodiments, the base binary sequence comprises the concatenation of multiple repetitions of a base binary subsequence. In one or more of these embodiments, a length of each auxiliary binary sequence is equal to the number of the multiple repetitions. Regardless, in some embodiments, determining which, if any, of the binary sequences matches the received signal comprises, for each of multiple sequential blocks of the received signal with a length corresponding to a length of the base binary sequence, correlating the block with the base binary subsequence, and determining which of the binary sequences matches the received signal by determining which of multiple candidate correlation peak patterns associated with respective ones of the binary sequences results from correlating. In one or more of these embodiments, determining which of multiple candidate correlation peak patterns associated with respective ones of the binary sequences results from correlating comprises, for each correlation peak resulting from the correlation, obtaining a correlation peak detection metric indicating whether the correlation peak is above or below a detection threshold, and determining which of the auxiliary binary sequences corresponds to a sequence formed from the correlation peak detection metrics. In other embodiments, determining which of multiple candidate correlation peak patterns associated with respective ones of the binary sequences results from correlating comprises, from correlation peaks resulting from correlating, obtaining different combined correlation peak detection metrics corresponding to the auxiliary binary sequences, and determining which of the binary sequences matches the received signal based on which of the combined correlation peak detection metrics exceeds a detection threshold.

In other embodiments, the cell-specific wake-up signal 20 in FIG. 1 is formed by multiple Zadoff-Chu (ZC) sequences with different roots, e.g., a pair of Zadoff-Chu sequences with different roots. In some embodiments, at least one of the multiple Zadoff-Chu sequences is a complex conjugate of at least one other of the multiple Zadoff-Chu sequences. Regardless, in some embodiments, the cell-specific wake-up signal 20 is formed by a concatenation of the multiple Zadoff-Chu sequences with different roots, e.g., concatenation in the time domain and/or the frequency domain.

As applied for multiple cells, then, some embodiments compose multiple cell-specific wake-up signals in a set from different sets of Zadoff-Chu sequences with different roots, or the same set of Zadoff-Chu sequences with different cyclic shifts. In some embodiments, the multiple cell-specific wake-up signals are formable from a set of root Zadoff-Chu sequences. In one such embodiment, information may be broadcast in a cell for use in determining the set of root Zadoff-Chu sequences, e.g., the information may implicitly indicate the set of root Zadoff-Chu sequences by indicating one or more of a set of cell identities, a synchronization signal block configuration, or registration or tracking area information.

More particularly, in one embodiment, a cell-specific wake-up signal 20 is designed by using a pair of Zadoff-Chu (ZC) sequences of lengths n1 and n2 and different roots ul1 and u2. In these and other embodiments, the wake-up signal 20 can not only act as a wake-up signal but also enable the first communication node 10 to acquire time and/or frequency synchronization in the downlink using the wake-up receiver 12W (without having to switch to the main receiver 12R). The reason for using two ZC sequences with different roots is to make the wake-up signal 20 more robust to carrier frequency offset (CFO). This robustness towards frequency errors will support the enabling of a wake-up receiver 12W design based on a low power, low accuracy and low cost frequency reference. This is because a ZC sequence is inherently vulnerable to a CFO larger than half the subcarrier spacing (SCS). It typically perturbs the location of the peak in the correlator output, leading to incorrect detection of delay and CFO. Consequently, amid a large CFO, the receiver would not be able to unambiguously determine the propagation delay and the CFO if only 1 ZC sequence is used. By utilizing 2 ZC sequences with different roots, it is possible to determine the actual delay and the CFO experienced by the received signal.

Consider now additional details of these embodiments. For ease of exposition, assume n=n1=n2 in the following text. There are n−1 unique root sequences possible for a sequence of length n when n is a prime number. When each wake-up signal (WUS) is based on a pair of ZC sequences using two unique roots, there are U unique root WUS possible where each WUS is generated using a unique root pair, and floor (.) is the integer floor function.

There are up to

$$\frac{( n - 1 ) \times ( n - 2 )}{2}$$

unique root WUS possible such that no two root WUS have the same root pairs. Note that for each root WUS with roots μ₁ and μ₂, one may also consider its “mirror image” WUS (i.e., the WUS with roots μ₂ and μ₁) as a distinct WUS even though both have the same root pairs. If mirror images are considered, then there can be up to (n−1)×(n−2) unique root WUS possible.

In another embodiment, the second sequence in a pair can be obtained by taking a complex conjugate of the first sequence. In this special case, the root of the second sequence is given by μ₂=n−μ₁ mod n, where n is the sequence length and modulo arithmetic is assumed. As a result, each WUS can be uniquely identified by specifying only a single root (1 since the second root is a known function of the first root.

There are up to

$$\frac{( n - 1 )}{2}$$

unique root WUS possible where each WUS is generated using a unique root pair. Note that if the mirror image of each root WUS is considered as a distinct WUS, then there can be up to (n−1) unique root WUS possible.

For each unique root WUS, it is possible to further generate up to V orthogonal WUS (including the root WUS) by cyclically shifting the root WUS. All such sequences will correspond to the same root pair. In particular, cyclically shifting a root WUS means that each constituent ZC sequence of the root WUS is cyclically shifted by a certain amount, i.e., sequence 1 shifted by c_1 samples while sequence 2 shifted by c_2 samples, where c_1 and c_2 may or may not be the same.

Note that for a length n ZC sequence, the cyclic shift from 0, . . . , n−1 yield n orthogonal ZC sequences where a cyclic shift of 0 corresponds to the root ZC sequence. Further note that a root WUS is constructed from 2 length n ZC sequences. If the same cyclic shift value is applied to both sequences, a root WUS can be used to generate up to n orthogonal WUS including the root WUS. If cyclic shift values for both sequences are not restricted to be the same and can be chosen independently of each other, a root WUS can be used to generate up to n² orthogonal WUS including the root WUS.

In total, there can be up to W=U×V unique WUS where all the WUS generated from the same root WUS are orthogonal. The WUS generated from different root WUS will not typically be orthogonal but are expected to have a low cross-correlation.

In another embodiment, the WUS can be generated by concatenating the 2 ZC sequences in time domain or by concatenating the 2 ZC sequences in frequency domain or by jointly transmitting the 2 ZC sequences using the same time/frequency resources. For efficient processing, the first communication node 12 needs to know the time-domain and/or frequency domain structure of the WUS generated in this way. This can be either fixed in a governing communications specification or signalled by the network 10 using System Information (SI).

In one embodiment, a cell-specific WUS 20 is designed by assigning up to M unique root WUS to up to M cells. In a sub-embodiment, the “M” unique root WUS can be specified in a governing communications specification and known to the first and second communication nodes 12, 14. If the root WUS used in a cell is not known to the first communication node 12, though, the first communication node 12 in some embodiments blindly tests up to M hypotheses to correctly detect the cell-specific WUS 20. Alternatively, the unique root WUS can be tied to other information broadcast in a cell and fixed in a governing communications specification. For example, each of the M root WUS can be mapped to a set of Physical Cell Identities (PCIDs), and/or Synchronization Signal Block (SSB) configurations, or registration/tracking area information, or any combination thereof. When the first communication node 10 detects one or more of this information during initial synchronization/attach, the first communication node 10 can infer the root WUS configured in the cell. Note, though, that the second communication node 14 in some embodiments may indicate which of the M unique root WUS is configured in a given cell, e.g., using SI. As a result, the first communication node 12 in this case would need not test multiple hypotheses for the root WUS. Alternatively, the second communication node 14 may indicate the root pairs used for generating the root WUS configured in the given cell using SI.

In another embodiment, the cell-specific root WUS can be used to generate group WUS for one or more groups of communication nodes within a cell, e.g., by cyclically shifting the root WUS for that cell. In particular, cyclically shifting a root WUS means that each constituent ZC sequence is cyclically shifted i.e., sequence 1 shifted by c_1 samples while sequence 2 shifted by c_2 samples, where c_1 and c_2 may or may not be the same.

Note that for a length n ZC sequence, the cyclic shift from 0, . . . , n−1 yield n orthogonal ZC sequences where a cyclic shift of 0 corresponds to the root ZC sequence. Further note that a root ZC sequence is constructed from 2 length n ZC sequences. If the same cyclic shift value is applied to both sequences, a root WUS can be used to generate up to n orthogonal WUS including the root WUS. If cyclic shift values for both sequences are not restricted to be the same and can be chosen independently of each other, a root WUS can be used to generate up to n² orthogonal WUS including the root WUS.

In a sub-embodiment, the ‘V’ cyclic shift value pairs {c_{1.i}, c_{2.i}} where i=1, . . . , V used for generating V orthogonal group WUS from a root WUS (including the root WUS) can be specified in a governing communications specification or configured by the network 10 and made known to the first and second communication nodes 12, 14. Note that for the case where same cyclic shift values are applied for both ZC sequences, a single cyclic shift value is needed to characterize a WUS. If the first communication node 12 does not know the cyclic shift values used for generating the group WUS in its cell, it may need to blindly test multiple hypotheses to correctly detect the correct group WUS. Alternatively, the second communication node 14 may indicate which of the V cycle shift values are configured in a given cell using SI. As a result, the first communication node 12 need only test the hypotheses for the group WUS intended for it. Alternatively, a set of K unique root WUS is allocated to each cell. This allows up to K*V unique WUS to be used within each cell that can be assigned to wake up K*V communication nodes or groups of communication nodes.

In some embodiments, then, the first communication node 12 monitors for the cell-specific wake-up signal 20 by monitoring for any of multiple cell-specific group wake-up signals in a set. In one embodiment, the cell-specific group wake-up signals may be cell-specific wake-up signals for different groups of first communication nodes and are a function of different cyclic shifts of a root wake-up signal. Here, the root wake-up signal may be formed by multiple Zadoff-Chu sequences with different roots. As one example of this described above, cyclically shifting the root wake-up signal may mean that each constituent ZC sequence is cyclically shifted i.e., sequence 1 shifted by c_1 samples while sequence 2 shifted by c_2 samples, where c_1 and c_2 may or may not be the same.

In other embodiments herein, the cell-specific wake-up signal 20 is based on a binary error correcting code. In some embodiments, for example, the wake-up signal is one of multiple cell-specific wake-up signals in a set, where different cell-specific wake-up signals in the set are based on different codewords of a binary error correcting code. In one or more of these embodiments, the different cell-specific wake-up signals in the set are formed from the modulo-two addition of different codewords with different pseudo-random sequences.

According to some embodiment, for example, the WUS 20 is generated by the use of a binary error correcting code, e.g., a block code. In one embodiment, an (n.k) block code is used to generate a WUS of length n binary symbols (possibly Manchester coded). The k information bits used to generate the respective codeword are preferably allocated to the different cells depending on the frequency reuse. Suppose e.g., that a binary (63,10) Bose-Chaudhuri-Hocquenghem (BCH) code is used. In case the frequency reuse is 3, two out of the ten bits may be cell-specific whereas the eight remaining bits are allocated to the different communication nodes within a cell. As an example, in cell I, the second communication node 14 may set the two first bits to 00 and then use the remaining eight bits to address up to 256 communication nodes uniquely. Similarly, in cell II, the second communication node 14 may set the two first bits to 01 and use the remaining bits to address 256 communication nodes uniquely. In this way, the address space is divided between the different cells in a way that ensures that interference between cells is kept low. The distance properties of the codes are well known and therefore this also allows for a simple means to determine what is a suitable code length.

In case a larger reuse would be needed, say reuse 7, then the exact same code may be used. However, in this case, three bits may be cell-specific and the remaining seven bits can be distributed to different devices within the cell.

Although a design based on error correcting codes ensures good distances between different codewords, this good distance is assuming that the codewords are aligned. That is, given that one has obtained synchronization, the distance can be guaranteed. However, if the codes are cyclic, i.e., a cyclic shift of a codeword is also a codeword, then distance between one codeword and shifted version of another codeword is zero. In embodiments where the wake-up receiver 12W is correlating against one specific codeword, this means that all codewords obtained by cyclic shift may actually have very poor distance properties. In order to benefit from the effective construction of WUSs based on error correcting codes, without suffering the above-mentioned disadvantage, two additional features may preferably be used together with the above mentioned construction.

In the first approach all cyclic shifts are excluded. As the number of distinct codewords are 2\hat{ }k and this is something that only needs to be done once, this may be done off-line for, say, k on the order of 20 or less. One may note that due to this removal of codewords, one may have to select a larger k in order to obtain a sufficiently large number of allowed WUSs.

In the second approach, a predetermined pseudo-random sequence is exclusively OR′ed (XORed) with the codewords to generate the WUS. The distance properties will be maintained, but the likelihood that a cyclic shift of one WUS will be another valid WUS will become very small.

Other embodiments herein form the cell-specific wake-up signal 16 from a sequence that is orthogonal to other sequences used for other cell-specific wake-up signals. In some embodiments, for example, different cell-specific wake-up signals in a set are based on different orthogonal sequences in a set. In one or more of these embodiments, the different orthogonal sequences each comprise a cell-specific subsequence concatenated with a device-addressing subsequence, and orthogonal sequences specific to different cells are formed from different cell-specific subsequences.

According to one example of these embodiments, a WUS of length n binary symbols is used and a sequence of n¹ bits of the WUS is used to allocate to the different cells depending on the frequency reuse. The remaining n−n¹ bits are allocated to the different communication nodes within a cell. The cell specific sequences (with n¹ bits) are selected so that they are orthogonal. For example, for the case the frequency reuse is 3 as in FIG. 2A, the sequences [1,0,0,1,0,0,1,0,0], [0,1,0,0,1,0,0,1,0], and [0,0,1,0,0,1,0,0,1] can be assigned respectively to cell I, cell II, and cell III. Note that the length n₁ can be selected large enough to ensure a certain distance between the cell assigned sequences.

One benefit of this embodiment is that the wake-up receiver 12W doesn't need a complex decoder. However, for a given n¹ bit associated with cell identification, the error correcting code may provide stronger error detecting and correcting ability.

In some embodiments, a cell-specific wake-up signal 20 carries information that indicates a cell identity of a cell for which the cell-specific wake-up signal 20 is specific. In one embodiment, for example, a cell identifier is added as information in the WUS 20. That is, a cell ID of N bits is carried in the WUS and allows for 2^{N} different cell IDs. In this case, the first communication node 12 may decode the WUS 20, and the associated hardware start up may be longer as compared to direct matching on the physical layer (i.e., very basic correlation or energy detection).

However, note that the first communication node 12 would still not have to start up the main receiver 12R though. In a cellular network, useful values for frequency reuse are M={1,3,4,7,9, 12, 13, 16, 19, . . . }. Therefore, since M=2^{N} for M={4, 16, . . . } (M=1 is not a useful value), there will in practice be unused code points. In legacy approaches, 1008 different Physical Cell Identities (PCIs) are used, so, in order to not have a worse problem with “cell confusion”, N would have to be no less than 10 (2\hat{ }10=1024).

In an addition to this embodiment, these unused code points could be used for any of the following. The unused code points may be used for a common WUS to wake up, or address, all communication nodes in the network 10 irrespective of cell. For example, if N=3, 7 different cell IDs can be used for the WUS but the eight code point ([1,1,1]) could be used to wake up any device in any cell. Or, the unused code points may be used as an indication to cancel wake-up receiver operation or exit wake-up receiver operating state.

Note that some embodiments herein are described for downlink transmission, where the first communication node 12 is a communication device and the second communication node 14 is a network node. However, embodiments herein equally apply also to uplink transmission, where the first communication node 12 is a network node (e.g., equipped with a wake-up receiver 12W) and the second communication node 14 is a communication device. Similarly, embodiments herein equally apply to sidelink transmission, where both the first and second communication nodes are communication devices.

Note also that although embodiments may be applied for a New Radio (NR) network, embodiments herein may be equally applicable to Long Term Evolution (LTE), e.g., Narrowband Internet of Things (NB-IoT) or LTE for Machines (LTE-M), or any 6G network.

Some embodiments herein, for example, are applicable in the following context. In some embodiments, receiver 12R is a baseband receiver and/or a receiver that consumes higher power than wake-up receiver 12W. The wake-up receiver 12W wakes up receiver 12R to detect an incoming message, e.g., a paging message such as a message on PDCCH in paging occasions or a message scheduling the paging message on PDSCH. One benefit of this is lower energy consumption and longer device battery life, or at a fixed energy consumption the downlink latency can be reduced (shorter DRX/duty-cycles and more frequent checks for incoming transmissions).

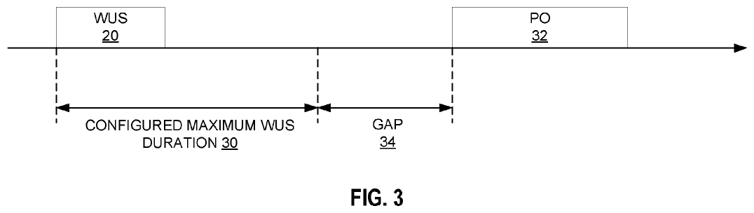

Some embodiments for example are applicable to or based on a Rel-15 WUS, e.g., as specified for Narrowband Internet of Things (NB-IoT) and LTE-M. One motivation is energy consumption reduction since with coverage enhancement PDCCH may be repeated many times and the WUS is relatively shorter and hence requires less reception time. In this case, the wake-up receiver 12W checks for a WUS a certain time before the first communication node's paging occasion (PO), and only if a WUS is detected, the first communication node 12 continues to check for PDCCH in the PO, and if not, which is most of the time, to first communication node 12 can go back to a sleep state to conserve energy. Due to the coverage enhancements, the WUS can be of variable length depending on the first communication node's coverage. FIG. 3 shows one example in this regard. In such a case, a wake-up signal occasion 30 as used herein may span the configured maximum wake-up signal duration 32. In one such embodiment shown, there may be a gap 36 in time between the end of the maximum WUS duration 32 and the next PO 34.

In these and other embodiments the wake-up signal 20 may be based on the transmission of a short signal that indicates to the first communication node 10 that it should continue to decode a downlink control channel, e.g., full Narrowband PDCCH, NPDCCH, for NB-IoT. If such signal is absent (DTX i.e., the first communication node 12 does not detect it) then the first communication node 12 can go back to sleep without decoding the downlink control channel. The decoding time for the wake-up signal 16 may be considerably shorter than that of the full NPDCCH since it essentially only needs to contain one bit of information whereas the NPDCCH may contain up to 35 bits of information. This, in turn, reduces power consumption and leads to longer battery life. The wake-up signal 20 in some embodiments is transmitted only when there is paging for the first communication node 12. But if there is no paging for the first communication node 12 then the wake-up signal 20 will not be transmitted (i.e., implying a discontinuous transmission, DTX) and the first communication node 12 would go back to sleep, e.g., upon detecting DTX instead of the wake-up signal 20.

In some embodiments, though, the wake-up signal 20 is not PDCCH-based. Rather, the wake-up signal 20 is designed for reception by a simpler and low power receiver, i.e., wake-up receiver 12W. The wake-up signal 20 may for example be based on on-off keying (OOK) modulation and non-coherent detection.

Some embodiments herein address certain challenge(s) in this context. In NB-IoT and LTE-M the sequence-based WUS is scrambled with a physical cell ID (PCID) to avoid that UEs are unnecessarily woken up by WUSs transmitted in adjacent cells. However, when WUS is designed for a low power WUR (e.g. using on-off keying OOK, FSK, PSK, ASK and non-coherent detection), it is not straight-forward how to achieve cell-specific WUS. Embodiments herein in this regard enable cell-specific WUS for a WUS which is designed for a lower power WUR.

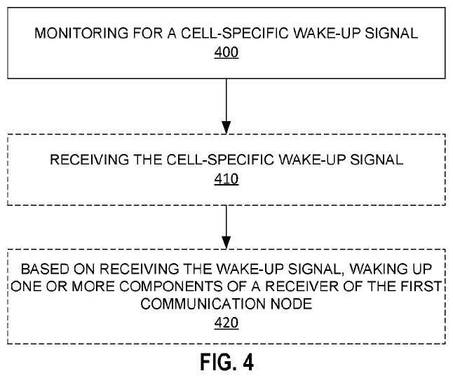

In view of the modifications and variations herein, FIG. 4 depicts a method performed by a first communication node 12 in accordance with particular embodiments. The method includes monitoring for a cell-specific wake-up signal 20, e.g., with a wake-up receiver 12W

(Block 400). In some embodiments, the method further comprises receiving the cell-specific wake-up signal 20, e.g., with the wake-up receiver 12W (Block 410). In one or more embodiments, the method also comprises, based on receiving the cell-specific wake-up signal 20, waking up one or more components of a receiver 12R of the first communication node 12 (Block 420).

In some embodiments, monitoring for a cell-specific wake-up signal comprises monitoring for any of multiple cell-specific wake-up signals in a set.

In some embodiments, the set of cell-specific wake-up signals is re-used for different sets of cells in a wireless communication network according to a reuse pattern, with each cell-specific wake-up signal being specific to one of multiple cells in a set of cells.

In some embodiments, the multiple cell-specific wake-up signals in the set are based on multiple respective binary sequences. In one such embodiment, monitoring comprises receiving a signal and determining which, if any, of the binary sequences matches the received signal.

In some embodiments where the multiple cell-specific wake-up signals in the set are based on multiple respective binary sequences, different ones of the binary sequences are a function of a base binary sequence with different respective auxiliary binary sequences.

In some embodiments, different ones of the binary sequences are formed from the modulo-two addition of the base binary sequence with different respective auxiliary binary sequences.

In some embodiments, the binary sequences comprise two binary sequences, and the auxiliary binary sequences comprise two auxiliary binary sequences that are orthogonal to one another. In one or more of these embodiments, determining which, if any, of the binary sequences matches the received signal comprises correlating the received signal with the base binary sequence and determining which of the binary sequences matches the received signal based on whether a correlation peak from said correlating is greater than or less than a detection threshold.

In other embodiments, the binary sequences comprise three or four binary sequences, and the auxiliary binary sequences comprises three or four auxiliary binary sequences that are orthogonal to one another.

In these and other embodiments, the base binary sequence may comprise the concatenation of multiple repetitions of a base binary subsequence. In one or more of these embodiments, a length of each auxiliary binary sequence may be equal to the number of the multiple repetitions.

In some embodiments where the base binary sequence comprises the concatenation of multiple repetitions of a base binary subsequence, determining which, if any, of the binary sequences matches the received signal comprises, for each of multiple sequential blocks of the received signal with a length corresponding to a length of the base binary sequence, correlating the block with the base binary subsequence, and determining which of the binary sequences matches the received signal by determining which of multiple candidate correlation peak patterns associated with respective ones of the binary sequences results from correlating. In one or more of these embodiments, determining which of multiple candidate correlation peak patterns associated with respective ones of the binary sequences results from correlating comprises, for each correlation peak resulting from said correlating, obtaining a correlation peak detection metric indicating whether the correlation peak is above or below a detection threshold, and determining which of the auxiliary binary sequences corresponds to a sequence formed from the correlation peak detection metrics. In other embodiments, determining which of multiple candidate correlation peak patterns associated with respective ones of the binary sequences results from correlating comprises, from correlation peaks resulting from correlating, obtaining different combined correlation peak detection metrics corresponding to the auxiliary binary sequences, and determining which of the binary sequences matches the received signal based on which of the combined correlation peak detection metrics exceeds a detection threshold.

In some embodiments, the cell-specific wake-up signal is formed by multiple Zadoff-Chu sequences with different roots. In one or more of these embodiments, the multiple Zadoff-Chu sequences are a pair of Zadoff-Chu sequences. In some embodiments, at least one of the multiple Zadoff-Chu sequences is a complex conjugate of at least one other of the multiple Zadoff-Chu sequences. In some embodiments, the cell-specific wake-up signal is formed by a concatenation of the multiple Zadoff-Chu sequences with different roots. In some embodiments, the concatenation is in the time domain and/or the frequency domain.

In some embodiments, monitoring for a cell-specific wake-up signal comprises monitoring for any of multiple cell-specific wake-up signals in a set. In some embodiments, at least some of the cell-specific wake-up signals in the set are composed of different sets of Zadoff-Chu sequences with different roots, or the same set of Zadoff-Chu sequences with different cyclic shifts. In some embodiments, the multiple cell-specific wake-up signals are formable from a set of root Zadoff-Chu sequences. In this case, the method further comprises receiving information broadcast in a cell and determining the set of root Zadoff-Chu sequences from the information, and the information indicates one or more of a set of cell identities, a synchronization signal block configuration, or registration or tracking area information.

In some embodiments, monitoring for a cell-specific wake-up signal comprises monitoring for any of multiple cell-specific group wake-up signals in a set. In this case, the cell-specific group wake-up signals are cell-specific wake-up signals for different groups of first communication nodes and are a function of different cyclic shifts of a root wake-up signal, and the root wake-up signal is formed by multiple Zadoff-Chu sequences with different roots.

In some embodiments, the cell-specific wake-up signal is based on a binary error correcting code.

In some embodiments, monitoring for a cell-specific wake-up signal comprises monitoring for any of multiple cell-specific wake-up signals in a set. In this case, different cell-specific wake-up signals in the set are based on different codewords of a binary error correcting code. In some embodiments, the different cell-specific wake-up signals in the set are formed from the modulo-two addition of different codewords with different pseudo-random sequences.

In some embodiments, monitoring for a cell-specific wake-up signal comprises monitoring for any of multiple cell-specific wake-up signals in a set. In this case, different cell-specific wake-up signals in the set are based on different orthogonal sequences in a set. In some embodiments, the different orthogonal sequences each comprise a cell-specific subsequence concatenated with a device-addressing subsequence, and orthogonal sequences specific to different cells are formed from different cell-specific subsequences.

In some embodiments, the cell-specific wake-up signal carries information that indicates a cell identity of a cell for which the cell-specific wake-up signal is specific.

In some embodiments, monitoring for a cell-specific wake-up signal comprises monitoring for at least some different cell-specific wake-up signals in different radio resources. In one or more of these embodiments, at least some of the different radio resources are non-overlapping in time and/or frequency.

In some embodiments, monitoring for a cell-specific wake-up signal comprises monitoring for at least some different cell-specific wake-up signals that have different periodicities, frequency hopping patterns, and/or repetition factors.

In some embodiments, monitoring for the cell-specific wake-up signal comprises monitoring for the cell-specific wake-up signal using non-coherent detection.

In some embodiments, the cell-specific wake-up signal is an OOK signal, an FSK signal, a PSK signal, or an ASK signal.

In some embodiments, monitoring comprises monitoring for the cell-specific wake-up signal with a wake-up receiver of the first communication node. In some embodiments, the wake-up receiver is a non-coherent receiver. In some embodiments, the method further comprises receiving the cell-specific wake-up signal with the wake-up receiver. In some embodiments, the method further comprises, based on receiving the wake-up signal, waking up one or more components of another receiver of the first communication node.

In some embodiments, the method further comprises, based on the wake-up signal, performing time and/or frequency synchronization with a second communication node from which the wake-up signal is received.

In some embodiments, the multiple Zadoff-Chu sequences are jointly received using the same time-frequency resources.

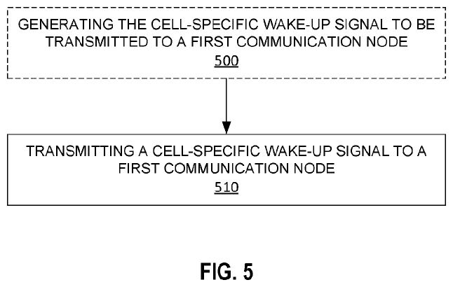

FIG. 5 depicts a method performed by a second communication node 14 in accordance with other particular embodiments. The method includes transmitting a cell-specific wake-up signal 16 to a first communication node 12, e.g., equipped with a wake-up receiver 12W (Block 510). The cell-specific wake-up signal 16 may for example be receivable with a wake-up receiver 12W. In some embodiments, the method also comprises generating the cell-specific wake-up signal 16 to be transmitted (Block 500).

In some embodiments, the cell-specific wake-up signal comprises any of multiple cell-specific wake-up signals in a set. In one or more of these embodiments, the set of cell-specific wake-up signals is re-used for different sets of cells in a wireless communication network according to a reuse pattern, with each cell-specific wake-up signal being specific to one of multiple cells in a set of cells. In one or more of these embodiments, the multiple cell-specific wake-up signals in the set are based on multiple respective binary sequences. In one or more of these embodiments, different ones of the binary sequences are a function of a base binary sequence with different respective auxiliary binary sequences. In one or more of these embodiments, different ones of the binary sequences are formed from the modulo-two addition of the base binary sequence with different respective auxiliary binary sequences. In one or more of these embodiments, the binary sequences comprise two binary sequences, and the auxiliary binary sequences comprise two auxiliary binary sequences that are orthogonal to one another. In one or more of these embodiments, the binary sequences comprise three or four binary sequences, and the auxiliary binary sequences comprises three or four auxiliary binary sequences that are orthogonal to one another. In one or more of these embodiments, the base binary sequence comprises the concatenation of multiple repetitions of a base binary subsequence. In one or more of these embodiments, a length of each auxiliary binary sequence is equal to the number of said multiple repetitions.

In some embodiments, the cell-specific wake-up signal is formed by multiple Zadoff-Chu sequences with different roots. In one or more of these embodiments, the multiple Zadoff-Chu sequences are a pair of Zadoff-Chu sequences. In some embodiments, at least one of the multiple Zadoff-Chu sequences is a complex conjugate of at least one other of the multiple Zadoff-Chu sequences. In some embodiments, the cell-specific wake-up signal is formed by a concatenation of the multiple Zadoff-Chu sequences with different roots. In some embodiments, the concatenation is in the time domain and/or the frequency domain.

In some embodiments, the cell-specific wake-up signal is one of multiple cell-specific wake-up signals in a set. In this case, at least some of the cell-specific wake-up signals in the set are composed of different sets of Zadoff-Chu sequences with different roots or the same set of Zadoff-Chu sequences with different cyclic shifts. In some embodiments, the multiple cell-specific wake-up signals are formable from a set of root Zadoff-Chu sequences. In this case, the method further comprises broadcasting information in a cell indicating one or more of a set of cell identities, a synchronization signal block configuration, or registration or tracking area information.

In some embodiments, the cell-specific wake-up signal comprises one of multiple cell-specific group wake-up signals in a set. In this case, the cell-specific group wake-up signals are cell-specific wake-up signals for different groups of first communication nodes and are a function of different cyclic shifts of a root wake-up signal, and the root wake-up signal is formed by multiple Zadoff-Chu sequences with different roots.

In some embodiments, the cell-specific wake-up signal is based on a binary error correcting code.

In some embodiments, the cell-specific wake-up signal is one of multiple cell-specific wake-up signals in a set. In this case, different cell-specific wake-up signals in the set are based on different codewords of a binary error correcting code. In one or more of these embodiments, the different cell-specific wake-up signals in the set are formed from the modulo-two addition of different codewords with different pseudo-random sequences.

In some embodiments, the cell-specific wake-up signal is one of multiple cell-specific wake-up signals in a set. In this case, different cell-specific wake-up signals in the set are based on different orthogonal sequences in a set. In one or more of these embodiments, the different orthogonal sequences each comprise a cell-specific subsequence concatenated with a device-addressing subsequence. In this case, orthogonal sequences specific to different cells are formed from different cell-specific subsequences.

In some embodiments, the cell-specific wake-up signal carries information that indicates a cell identity of a cell for which the cell-specific wake-up signal is specific.

In some embodiments, transmitting the cell-specific wake-up signal comprises transmitting the cell-specific wake-up signal in radio resources different from radio resources in which another cell-specific wake-up signal is transmitted. In one or more of these embodiments, transmitting the cell-specific wake-up signal comprises transmitting the cell-specific wake-up signal in radio resources that do not overlap in time and/or frequency with radio resources in which another cell-specific wake-up signal is transmitted.

In some embodiments, transmitting the cell-specific wake-up signal comprises transmitting at least some different cell-specific wake-up signals with different periodicities, frequency hopping patterns, and/or repetition factors.

In some embodiments, the cell-specific wake-up signal is an OOK signal, an FSK signal, a PSK signal, or an ASK signal.

In some embodiments, the first communication node is equipped with wake-up receiver.

In some embodiments, the cell-specific wake-up signal is receivable with a wake-up receiver. In one or more of these embodiments, the wake-up receiver is a non-coherent receiver.

In some embodiments, the multiple Zadoff-Chu sequences are jointly transmitted using the same time-frequency resources.

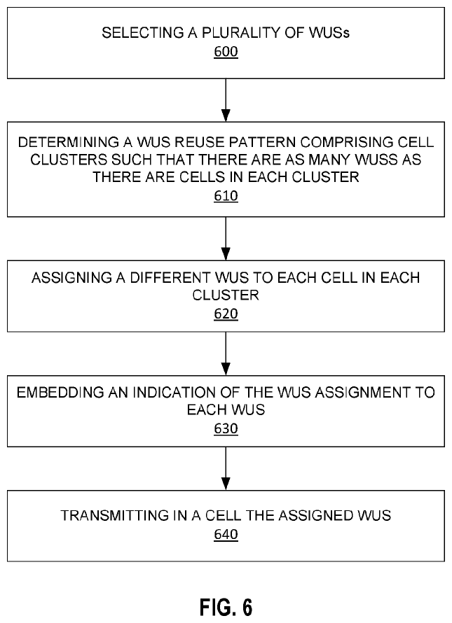

FIG. 6 depicts a method in a cellular network comprising a network node and a UE having a WUR. The network node may perform one or more of the steps shown for the method.

The method comprises selecting a plurality of WUSs (Block 600). The method also comprises determining a WUS reuse pattern comprising cell clusters such that there are as many WUSs as there are cells in each cluster (Block 610). The method further comprises assigning a different WUS to each cell in each cluster (Block 620). The method also comprises embedding an indication of the WUS assignment to each WUS (Block 630). The method also comprises transmitting in a cell the assigned WUS (Block 640).

In some embodiments, the embedding of the assignment indication comprises repetition of a base sequence, where each repetition may have a different sign and the pattern of signs indicates the assignment.

In some embodiments, the embedding of the assignment indication comprises two Zadoff-Chu sequences with different roots.

In some embodiments, the embedding of the assignment indication comprises including said assignment in the information bits of a codeword of an error correcting code.

In some embodiments, the embedding of the assignment indication comprises mapping the indication to orthogonal sequences.

In some embodiments, the embedding of the assignment indication comprises including a compressed cell identifier in the WUS.

In some embodiments, the embedding is performed by allocation non-overlapping time-frequency resources to each assignment.

In some embodiments, the embedding is performed by mapping each assignment to a different hopping pattern or repetition pattern.

Embodiments herein also include corresponding apparatuses. Embodiments herein for instance include a first communication node 12 configured to perform any of the steps of any of the embodiments described above for the first communication node 12.

Embodiments also include a first communication node 12 comprising processing circuitry and power supply circuitry. The processing circuitry is configured to perform any of the steps of any of the embodiments described above for the first communication node 12. The power supply circuitry is configured to supply power to the first communication node 12.

Embodiments further include a first communication node 12 comprising processing circuitry. The processing circuitry is configured to perform any of the steps of any of the embodiments described above for the first communication node 12. In some embodiments, the first communication node 12 further comprises communication circuitry.

Embodiments further include a first communication node 12 comprising processing circuitry and memory. The memory contains instructions executable by the processing circuitry whereby the first communication node 12 is configured to perform any of the steps of any of the embodiments described above for the first communication node 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the first communication node 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a second communication node 14 configured to perform any of the steps of any of the embodiments described above for the second communication node 14.

Embodiments also include a second communication node 14 comprising processing circuitry and power supply circuitry. The processing circuitry is configured to perform any of the steps of any of the embodiments described above for the second communication node 14. The power supply circuitry is configured to supply power to the second communication node 14.

Embodiments further include a second communication node 14 comprising processing circuitry. The processing circuitry is configured to perform any of the steps of any of the embodiments described above for the second communication node 14. In some embodiments, the second communication node 14 further comprises communication circuitry.

Embodiments further include a second communication node 14 comprising processing circuitry and memory. The memory contains instructions executable by the processing circuitry whereby the second communication node 14 is configured to perform any of the steps of any of the embodiments described above for the second communication node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

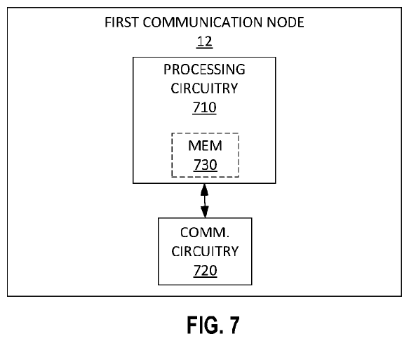

FIG. 7 for example illustrates a first communication node 12 as implemented in accordance with one or more embodiments. As shown, the first communication node 12 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the wireless communication device 700. The processing circuitry 710 is configured to perform processing described above, e.g., in FIG. 4, such as by executing instructions stored in memory 730. The processing circuitry 710 in this regard may implement certain functional means, units, or modules.

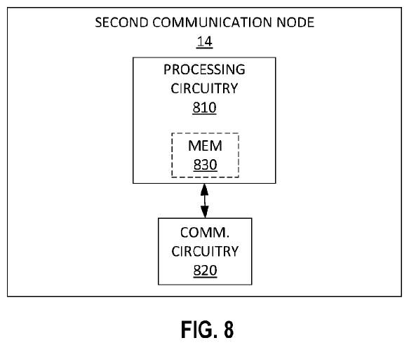

FIG. 8 illustrates a second communication node 14 as implemented in accordance with one or more embodiments. As shown, the second communication node 14 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 5, such as by executing instructions stored in memory 830. The processing circuitry 810 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

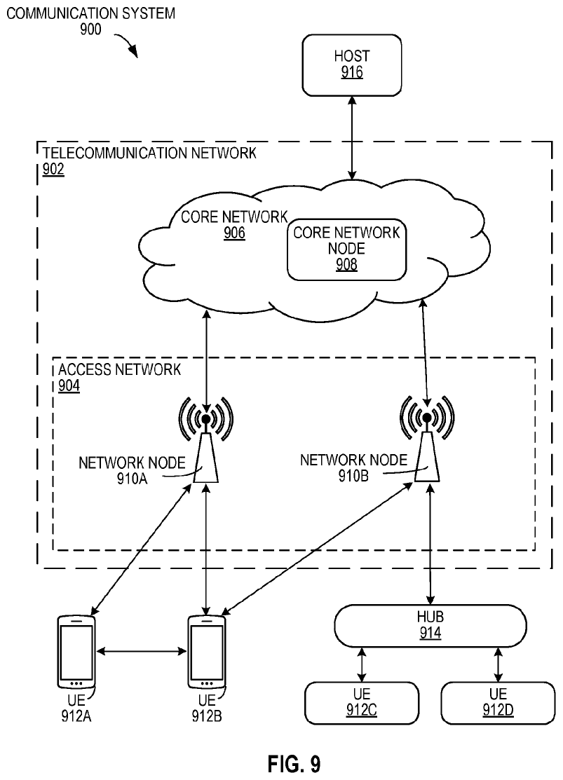

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non−3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

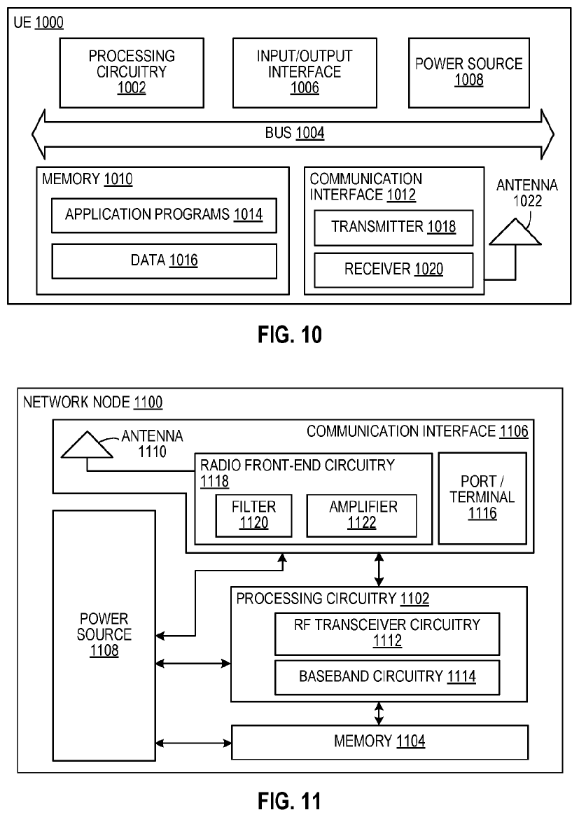

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

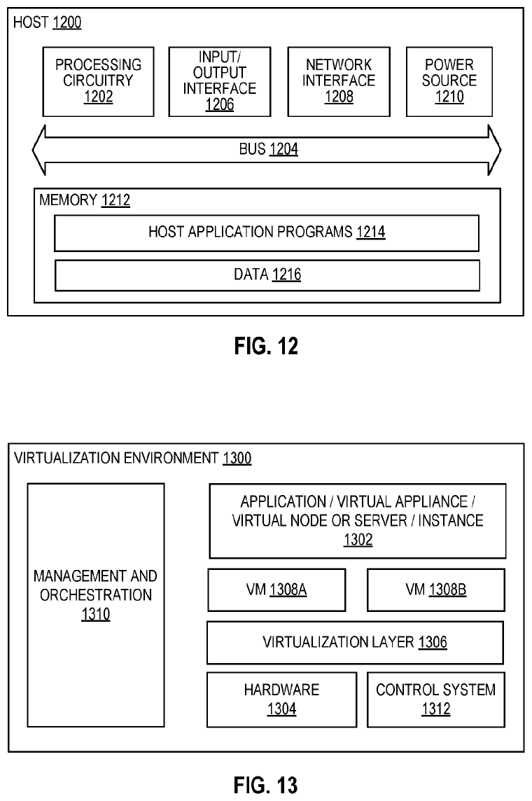

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

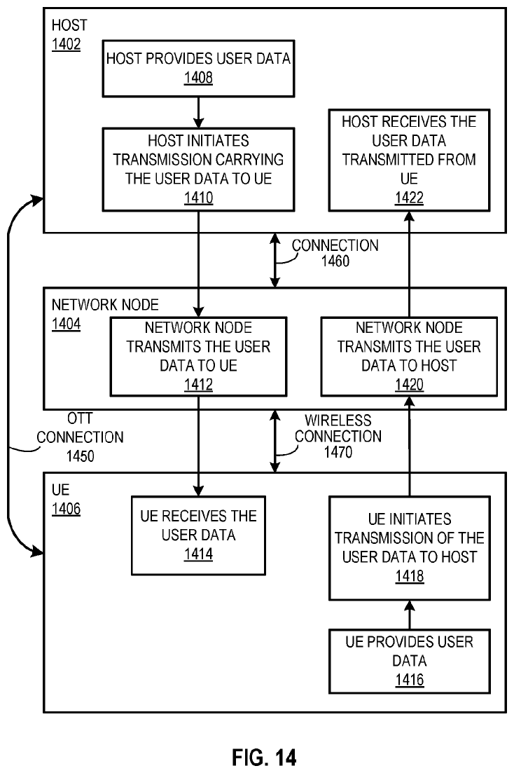

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a first communication node, the method comprising:
monitoring for a cell-specific wake-up signal.

A2. The method of embodiment A1, wherein monitoring for a cell-specific wake-up signal comprises monitoring for any of multiple cell-specific wake-up signals in a set.

A3. The method of embodiment A2, wherein the set of cell-specific wake-up signals is re-used for different sets of cells in a wireless communication network according to a reuse pattern, with each cell-specific wake-up signal being specific to one of multiple cells in a set of cells.

A4. The method of any of embodiments A2-A3, wherein the multiple cell-specific wake-up signals in the set are based on multiple respective binary sequences, and wherein said monitoring comprises receiving a signal and determining which, if any, of the binary sequences matches the received signal.

A5. The method of embodiment A4, wherein different ones of the binary sequences are a function of a base binary sequence with different respective auxiliary binary sequences.

A6. The method of embodiment A5, wherein different ones of the binary sequences are formed from the modulo-two addition of the base binary sequence with different respective auxiliary binary sequences.

A7. The method of embodiment A6, wherein the binary sequences comprise two binary sequences, and wherein the auxiliary binary sequences comprise two auxiliary binary sequences that are orthogonal to one another.

A8. The method of any of embodiments A6-A7, wherein determining which, if any, of the binary sequences matches the received signal comprises:
correlating the received signal with the base binary sequence; and
determining which of the binary sequences matches the received signal based on whether a correlation peak from said correlating is greater than or less than a detection threshold.

A9. The method of embodiment A6, wherein the binary sequences comprise three or four binary sequences, and wherein the auxiliary binary sequences comprises three or four auxiliary binary sequences that are orthogonal to one another.

A10. The method of any of embodiments A6 and A9, wherein the base binary sequence comprises the concatenation of multiple repetitions of a base binary subsequence.

A11. The method of embodiment A10, wherein a length of each auxiliary binary sequence is equal to the number of said multiple repetitions.

A12. The method of any of embodiments A10-A11, wherein determining which, if any, of the binary sequences matches the received signal comprises:
for each of multiple sequential blocks of the received signal with a length corresponding to a length of the base binary sequence, correlating the block with the base binary subsequence; and
determining which of the binary sequences matches the received signal by determining which of multiple candidate correlation peak patterns associated with respective ones of the binary sequences results from said correlating.

A13. The method of embodiment A12, wherein determining which of multiple candidate correlation peak patterns associated with respective ones of the binary sequences results from said correlating comprises:
for each correlation peak resulting from said correlating, obtaining a correlation peak detection metric indicating whether the correlation peak is above or below a detection threshold; and
determining which of the auxiliary binary sequences corresponds to a sequence formed from the correlation peak detection metrics.

A14. The method of embodiment A12, wherein determining which of multiple candidate correlation peak patterns associated with respective ones of the binary sequences results from said correlating comprises:
from correlation peaks resulting from said correlating, obtaining different combined correlation peak detection metrics corresponding to the auxiliary binary sequences; and
determining which of the binary sequences matches the received signal based on which of the combined correlation peak detection metrics exceeds a detection threshold.

A15. The method of any of embodiments A1-A3, wherein the cell-specific wake-up signal is formed by multiple Zadoff-Chu sequences with different roots.

A16. The method of embodiment A15, wherein the multiple Zadoff-Chu sequences are a pair of Zadoff-Chu sequences.

A17. The method of any of embodiments A15-A16, wherein at least one of the multiple Zadoff-Chu sequences is a complex conjugate of at least one other of the multiple Zadoff-Chu sequences.

A18. The method of any of embodiments A15-A17, wherein the cell-specific wake-up signal is formed by a concatenation of the multiple Zadoff-Chu sequences with different roots.

A19. The method of embodiment A18, wherein the concatenation is in the time domain and/or the frequency domain.

A20. The method of any of embodiments A1-A3 and A15-A19, wherein monitoring for a cell-specific wake-up signal comprises monitoring for any of multiple cell-specific wake-up signals in a set, wherein at least some of the cell-specific wake-up signals in the set are composed of: different sets of Zadoff-Chu sequences with different roots; or the same set of Zadoff-Chu sequences with different cyclic shifts.

A21. The method of embodiment A20, wherein the multiple cell-specific wake-up signals are formable from a set of root Zadoff-Chu sequences, wherein the method further comprises receiving information broadcast in a cell and determining the set of root Zadoff-Chu sequences from the information, wherein the information indicates one or more of:
a set of cell identities;
a synchronization signal block configuration; or registration or tracking area information.

A22. The method of any of embodiments A1-A21, wherein monitoring for a cell-specific wake-up signal comprises monitoring for any of multiple cell-specific group wake-up signals in a set, wherein the cell-specific group wake-up signals are cell-specific wake-up signals for different groups of first communication nodes and are a function of different cyclic shifts of a root wake-up signal, wherein the root wake-up signal is formed by multiple Zadoff-Chu sequences with different roots.

A23. The method of any of embodiments A1-A3, wherein the cell-specific wake-up signal is based on a binary error correcting code.

A24. The method of any of embodiments A1-A3 and A23, wherein monitoring for a cell-specific wake-up signal comprises monitoring for any of multiple cell-specific wake-up signals in a set, wherein different cell-specific wake-up signals in the set are based on different codewords of a binary error correcting code.

A25. The method of embodiment A24, wherein the different cell-specific wake-up signals in the set are formed from the modulo-two addition of different codewords with different pseudo-random sequences.

A26. The method of any of embodiments A1-A3, wherein monitoring for a cell-specific wake-up signal comprises monitoring for any of multiple cell-specific wake-up signals in a set, wherein different cell-specific wake-up signals in the set are based on different orthogonal sequences in a set.

A27. The method of embodiment A26, wherein the different orthogonal sequences each comprise a cell-specific subsequence concatenated with a device-addressing subsequence, wherein orthogonal sequences specific to different cells are formed from different cell-specific subsequences.

A28. The method of any of embodiments A1-A27, wherein the cell-specific wake-up signal carries information that indicates a cell identity of a cell for which the cell-specific wake-up signal is specific.

A29. The method of any of embodiments A1-A28, wherein monitoring for a cell-specific wake-up signal comprises monitoring for at least some different cell-specific wake-up signals in different radio resources.

A30. The method of embodiment A29, wherein at least some of the different radio resources are non-overlapping in time and/or frequency.

A31. The method of any of embodiments A1-A28, wherein monitoring for a cell-specific wake-up signal comprises monitoring for at least some different cell-specific wake-up signals that have different periodicities, frequency hopping patterns, and/or repetition factors.

A32. The method of any of embodiments A1-A31, wherein monitoring for the cell-specific wake-up signal comprises monitoring for the cell-specific wake-up signal using non-coherent detection.

A33. The method of any of embodiments A1-A32, wherein the cell-specific wake-up signal is an OOK signal, an FSK signal, a PSK signal, or an ASK signal.

A34. Reserved.

A35. The method of any of embodiments A1-A33, wherein said monitoring comprises monitoring for the cell-specific wake-up signal with a wake-up receiver of the first communication node.

A36. The method of embodiment A35, wherein the wake-up receiver is a non-coherent receiver.

A37. The method of any of embodiments A35-A36, further comprising receiving the cell-specific wake-up signal with the wake-up receiver.

A38. The method of embodiment A37, further comprising, based on receiving the wake-up signal, waking up one or more components of another receiver of the first communication node.

A39. The method of any of embodiments A1-A38, further comprising, based on the wake-up signal, performing time and/or frequency synchronization with a second communication node from which the wake-up signal is received.

A40. The method of any of embodiments A15-A17, wherein the multiple Zadoff-Chu sequences are jointly received using the same time-frequency resources.

A41. The method of any of embodiments A1-A40, wherein the first communication node is a wireless communication device.

A42. The method of any of embodiments A1-A40, wherein the first communication node is a network node in a wireless communication network.

A43. The method of any of embodiments A1-A41, wherein monitoring for a cell-specific wake-up signal comprises monitoring for a cell-specific wake-up signal from a second communication node, wherein the second communication node is a network node in a wireless communication network.

A44. The method of any of embodiments A1-A41, wherein monitoring for a cell-specific wake-up signal comprises monitoring for a cell-specific wake-up signal from a second communication node, wherein the second communication node is a wireless communication device.

AA. The method of any of the previous embodiments, further comprising:
providing user data; and forwarding the user data to a host computer via the transmission to a base station.

### Group B Embodiments

B1. A method performed by a second communication node, the method comprising:
transmitting a cell-specific wake-up signal to a first communication node.

B2. The method of embodiment B1, wherein the cell-specific wake-up signal comprises any of multiple cell-specific wake-up signals in a set.

B3. The method of embodiment B2, wherein the set of cell-specific wake-up signals is re-used for different sets of cells in a wireless communication network according to a reuse pattern, with each cell-specific wake-up signal being specific to one of multiple cells in a set of cells.

B4. The method of any of embodiments B2-B3, wherein the multiple cell-specific wake-up signals in the set are based on multiple respective binary sequences.

B5. The method of embodiment B4, wherein different ones of the binary sequences are a function of a base binary sequence with different respective auxiliary binary sequences.

B6. The method of embodiment B5, wherein different ones of the binary sequences are formed from the modulo-two addition of the base binary sequence with different respective auxiliary binary sequences.

B7. The method of embodiment B6, wherein the binary sequences comprise two binary sequences, and wherein the auxiliary binary sequences comprise two auxiliary binary sequences that are orthogonal to one another.

B8. Reserved.

B9. The method of embodiment B7, wherein the binary sequences comprise three or four binary sequences, and wherein the auxiliary binary sequences comprises three or four auxiliary binary sequences that are orthogonal to one another.

B10. The method of any of embodiments B7 and B9, wherein the base binary sequence comprises the concatenation of multiple repetitions of a base binary subsequence.

B11. The method of embodiment B10, wherein a length of each auxiliary binary sequence is equal to the number of said multiple repetitions.

B12. Reserved.

B13. Reserved.

B14. Reserved.

B15. The method of any of embodiments B1-B3, wherein the cell-specific wake-up signal is formed by multiple Zadoff-Chu sequences with different roots.

B16. The method of embodiment B15, wherein the multiple Zadoff-Chu sequences are a pair of Zadoff-Chu sequences.

B17. The method of any of embodiments B15-B16, wherein at least one of the multiple Zadoff-Chu sequences is a complex conjugate of at least one other of the multiple Zadoff-Chu sequences.

B18. The method of any of embodiments B15-B17, wherein the cell-specific wake-up signal is formed by a concatenation of the multiple Zadoff-Chu sequences with different roots.

B19. The method of embodiment B18, wherein the concatenation is in the time domain and/or the frequency domain.

B20. The method of any of embodiments B1-B3 and B15-B19, wherein the cell-specific wake-up signal is one of multiple cell-specific wake-up signals in a set, wherein at least some of the cell-specific wake-up signals in the set are composed of:
different sets of Zadoff-Chu sequences with different roots; or the same set of Zadoff-Chu sequences with different cyclic shifts.

B21. The method of embodiment B20, wherein the multiple cell-specific wake-up signals are formable from a set of root Zadoff-Chu sequences, wherein the method further comprises broadcasting information in a cell indicating one or more of:

a set of cell identities;
a synchronization signal block configuration; or registration or tracking area information.

B22. The method of any of embodiments B1-B21, wherein the cell-specific wake-up signal comprises one of multiple cell-specific group wake-up signals in a set, wherein the cell-specific group wake-up signals are cell-specific wake-up signals for different groups of first communication nodes and are a function of different cyclic shifts of a root wake-up signal, wherein the root wake-up signal is formed by multiple Zadoff-Chu sequences with different roots.

B23. The method of any of embodiments B1-B3, wherein the cell-specific wake-up signal is based on a binary error correcting code.

B24. The method of any of embodiments B1-B3 and B23, wherein the cell-specific wake-up signal is one of multiple cell-specific wake-up signals in a set, wherein different cell-specific wake-up signals in the set are based on different codewords of a binary error correcting code.

B25. The method of embodiment B24, wherein the different cell-specific wake-up signals in the set are formed from the modulo-two addition of different codewords with different pseudo-random sequences.

B26. The method of any of embodiments B1-B3, wherein the cell-specific wake-up signal is one of multiple cell-specific wake-up signals in a set, wherein different cell-specific wake-up signals in the set are based on different orthogonal sequences in a set.

B27. The method of embodiment B26, wherein the different orthogonal sequences each comprise a cell-specific subsequence concatenated with a device-addressing subsequence, wherein orthogonal sequences specific to different cells are formed from different cell-specific subsequences.

B28. The method of any of embodiments B1-B27, wherein the cell-specific wake-up signal carries information that indicates a cell identity of a cell for which the cell-specific wake-up signal is specific.

B29. The method of any of embodiments B1-B28, wherein transmitting the cell-specific wake-up signal comprises transmitting the cell-specific wake-up signal in radio resources different from radio resources in which another cell-specific wake-up signal is transmitted.

B30. The method of embodiment B29, wherein transmitting the cell-specific wake-up signal comprises transmitting the cell-specific wake-up signal in radio resources that do not overlap in time and/or frequency with radio resources in which another cell-specific wake-up signal is transmitted.

B31. The method of any of embodiments B1-B28, wherein transmitting the cell-specific wake-up signal comprises transmitting at least some different cell-specific wake-up signals with different periodicities, frequency hopping patterns, and/or repetition factors.

B32. Reserved.

B33. The method of any of embodiments B1-B32, wherein the cell-specific wake-up signal is an OOK signal, an FSK signal, a PSK signal, or an ASK signal.

B34. Reserved.

B35. The method of any of embodiments B1-B34, wherein the first communication node is equipped with wake-up receiver.

B36. The method of any of embodiments B1-B34, wherein the cell-specific wake-up signal is receivable with a wake-up receiver.

B37. The method of any of embodiments B35-B36, wherein the wake-up receiver is a non-coherent receiver.

B38. The method of any of embodiments B15-B17, wherein the multiple Zadoff-Chu sequences are jointly transmitted using the same time-frequency resources.

B39. The method of any of embodiments B1-B38, wherein the first communication node is a wireless communication device.

B40. The method of any of embodiments B1-B38, wherein the first communication node is a network node in a wireless communication network.

B41. The method of any of embodiments B1-B39, wherein the second communication node is a network node in a wireless communication network.

B42. The method of any of embodiments B1-B39, wherein the second communication node is a wireless communication device.

BB. The method of any of the previous embodiments, further comprising:
obtaining user data; and forwarding the user data to a host computer or a first communication node.

### Group C Embodiments

C1. A first communication node configured to perform any of the steps of any of the Group A embodiments.

C2. A first communication node comprising processing circuitry configured to perform any of the steps of any of the Group A embodiments.

C3. A first communication node comprising:
communication circuitry; and processing circuitry configured to perform any of the steps of any of the Group A embodiments.

C4. A first communication node comprising:
processing circuitry configured to perform any of the steps of any of the Group A embodiments; and power supply circuitry configured to supply power to the first communication node.

C5. A first communication node comprising:

processing circuitry and memory, the memory containing instructions executable by the processing circuitry whereby the first communication node is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a first communication node, causes the first communication node to carry out the steps of any of the Group A embodiments.

C8. A carrier containing the computer program of embodiment C7, wherein the carrier is one of an electronic signal, optical signal, radio signal, or computer readable storage medium.

C9. A second communication node configured to perform any of the steps of any of the Group B embodiments.

C10. A second communication node comprising processing circuitry configured to perform any of the steps of any of the Group B embodiments.

C11. A second communication node comprising:
communication circuitry; and
processing circuitry configured to perform any of the steps of any of the Group B embodiments.

C12. A second communication node comprising:
processing circuitry configured to perform any of the steps of any of the Group B embodiments;
power supply circuitry configured to supply power to the second communication node.

C13. A second communication node comprising:

processing circuitry and memory, the memory containing instructions executable by the processing circuitry whereby the second communication node is configured to perform any of the steps of any of the Group B embodiments.

C14. The second communication node of any of embodiments C9-C13, wherein the second communication node is a base station.

C15. A computer program comprising instructions which, when executed by at least one processor of a second communication node, causes the second communication node to carry out the steps of any of the Group B embodiments.

C16. The computer program of embodiment C14, wherein the second communication node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1.-45. (canceled)

46. A method performed by a first communication node in a wireless communication network, the method comprising:
monitoring, with a wake-up receiver of the first communication node, for a cell-specific wake-up signal that is any of multiple cell-specific wake-up signals in a set, wherein the set is re-used for different sets of cells and/or includes cell-specific wake-up signals that are:
based on multiple respective binary sequences;
based on different codewords of a binary error correcting code;
based on different orthogonal sequences in a set;
composed of different sets of Zadoff-Chu sequences with different roots;
composed of the same set of Zadoff-Chu sequences with different cyclic shifts; or
a function of different cyclic shifts of a root wake-up signal formed by multiple Zadoff-Chu sequences with different roots;
receiving the cell-specific wake-up signal with the wake-up receiver; and
based on receiving the wake-up signal, waking up one or more components of another receiver of the first communication node.

47. The method of claim 46, wherein the set of cell-specific wake-up signals is re-used for different sets of cells in the wireless communication network according to a reuse pattern, with each cell-specific wake-up signal being specific to one of multiple cells in a set of cells.

48. The method of claim 46, wherein the multiple cell-specific wake-up signals in the set are based on multiple respective binary sequences, and wherein said monitoring comprises receiving a signal and determining which, if any, of the binary sequences matches the received signal, wherein different ones of the binary sequences:
are a function of a base binary sequence with different respective auxiliary binary sequences; or
are formed from the modulo-two addition of the base binary sequence with different respective auxiliary binary sequences.

49. The method of claim 48, wherein either:
the binary sequences comprise two binary sequences, and wherein the auxiliary binary sequences comprise two auxiliary binary sequences that are orthogonal to one another; or
the binary sequences comprise three or four binary sequences, and wherein the auxiliary binary sequences comprises three or four auxiliary binary sequences that are orthogonal to one another.

50. The method of claim 48, wherein determining which, if any, of the binary sequences matches the received signal comprises:
correlating the received signal with the base binary sequence; and
determining which of the binary sequences matches the received signal based on whether a correlation peak from said correlating is greater than or less than a detection threshold.

51. The method of claim 48, wherein the base binary sequence comprises the concatenation of multiple repetitions of a base binary subsequence, wherein a length of each auxiliary binary sequence is equal to the number of said multiple repetitions, and wherein determining which, if any, of the binary sequences matches the received signal comprises:
for each of multiple sequential blocks of the received signal with a length corresponding to a length of the base binary sequence, correlating the block with the base binary subsequence; and
determining which of the binary sequences matches the received signal by determining which of multiple candidate correlation peak patterns associated with respective ones of the binary sequences results from said correlating,
wherein determining which of multiple candidate correlation peak patterns associated with respective ones of the binary sequences results from said correlating comprises:
obtaining, for each correlation peak resulting from said correlating, a correlation peak detection metric indicating whether the correlation peak is above or below a detection threshold, and determining which of the auxiliary binary sequences corresponds to a sequence formed from the correlation peak detection metrics; or
from correlation peaks resulting from said correlating, obtaining different combined correlation peak detection metrics corresponding to the auxiliary binary sequences, and determining which of the binary sequences matches the received signal based on which of the combined correlation peak detection metrics exceeds a detection threshold.

52. The method of claim 46, wherein at least some of the cell-specific wake-up signals in the set are composed of:
different sets of Zadoff-Chu sequences with different roots; or
the same set of Zadoff-Chu sequences with different cyclic shifts,
wherein the multiple cell-specific wake-up signals are formable from a set of root Zadoff-Chu sequences, wherein the method further comprises receiving information broadcast in a cell and determining the set of root Zadoff-Chu sequences from the information, wherein the information indicates one or more of:
a set of cell identities;
a synchronization signal block configuration; or
registration or tracking area information.

53. The method of claim 46, wherein the cell-specific wake-up signals are cell-specific wake-up signals for different groups of first communication nodes and are a function of different cyclic shifts of the root wake-up signal.

54. The method of claim 46, wherein different cell-specific wake-up signals in the set are based on different codewords of a binary error correcting code, wherein the different cell-specific wake-up signals in the set are formed from the modulo-two addition of different codewords with different pseudo-random sequences.

55. The method of claim 46, wherein different cell-specific wake-up signals in the set are based on different orthogonal sequences in a set, wherein the different orthogonal sequences each comprise a cell-specific subsequence concatenated with a device-addressing subsequence, wherein orthogonal sequences specific to different cells are formed from different cell-specific subsequences.

56. The method of claim 46, wherein the wake-up receiver is a non-coherent receiver, and wherein monitoring for the cell-specific wake-up signal comprises monitoring for the cell-specific wake-up signal using non-coherent detection.

57. The method of claim 46, wherein the cell-specific wake-up signal is an OOK signal, an FSK signal, a PSK signal, or an ASK signal.

58. The method of claim 46, further comprising, based on the wake-up signal, performing time and/or frequency synchronization with a second communication node from which the wake-up signal is received.

59. The method of claim 46, wherein the cell-specific wake-up signal carries information that indicates a cell identity of a cell for which the cell-specific wake-up signal is specific.

60. The method of claim 46, wherein said monitoring comprises monitoring for at least some different cell-specific wake-up signals that are in different radio resources, wherein at least some of the different radio resources are non-overlapping in time and/or frequency.

61. The method of claim 46, wherein said monitoring comprises monitoring for at least some different cell-specific wake-up signals that have different periodicities, frequency hopping patterns, and/or repetition factors.

62. A method performed by a second communication node in a wireless communication network, the method comprising:
transmitting, to a first communication node, a cell-specific wake-up signal that is any of multiple cell-specific wake-up signals in a set, wherein the set is re-used for different sets of cells and/or includes cell-specific wake-up signals that are:
based on multiple respective binary sequences;
based on different codewords of a binary error correcting code;
based on different orthogonal sequences in a set;
composed of different sets of Zadoff-Chu sequences with different roots;
composed of the same set of Zadoff-Chu sequences with different cyclic shifts; or
a function of different cyclic shifts of a root wake-up signal formed by multiple Zadoff-Chu sequences with different roots.

63. The method of claim 62, wherein the set of cell-specific wake-up signals is re-used for different sets of cells in the wireless communication network according to a reuse pattern, with each cell-specific wake-up signal being specific to one of multiple cells in a set of cells.

64. A first communication node configured for use in a wireless communication network, the first communication node comprising:
communication circuitry; and
processing circuitry configured to:
monitor, with a wake-up receiver of the first communication node, for a cell-specific wake-up signal that is any of multiple cell-specific wake-up signals in a set, wherein the set is re-used for different sets of cells and/or includes cell-specific wake-up signals that are:
based on multiple respective binary sequences;
based on different codewords of a binary error correcting code;
based on different orthogonal sequences in a set;
composed of different sets of Zadoff-Chu sequences with different roots;
composed of the same set of Zadoff-Chu sequences with different cyclic shifts; or
a function of different cyclic shifts of a root wake-up signal formed by multiple Zadoff-Chu sequences with different roots;
receive the cell-specific wake-up signal with the wake-up receiver; and
based on receiving the wake-up signal, wake up one or more components of another receiver of the first communication node.

65. A second communication node configured for use in a wireless communication network, the second communication node comprising:
communication circuitry; and
processing circuitry configured to transmit, to a first communication node, a cell-specific wake-up signal that is any of multiple cell-specific wake-up signals in a set, wherein the set is re-used for different sets of cells and/or includes cell-specific wake-up signals that are:
based on multiple respective binary sequences;
based on different codewords of a binary error correcting code;
based on different orthogonal sequences in a set;
composed of different sets of Zadoff-Chu sequences with different roots;
composed of the same set of Zadoff-Chu sequences with different cyclic shifts; or
a function of different cyclic shifts of a root wake-up signal formed by multiple Zadoff-Chu sequences with different roots.
